(19) United States
(12) Patent Application Publication
(10) Pub. No.: US 2024/0046219 A1
(43) Pub. Date: Feb. 8, 2024

(54) EVENT PLANNING AND MANAGEMENT

(71) Applicant: INSTAHANGOUTS INC., Aldie, VA (US)

(72) Inventors: Sushma Rani THALLURI, Louisville, KY (US); Ramya Talluri, Aldie, VA (US)

(21) Appl. No.: 17/882,838

(22) Filed: Aug. 8, 2022

(51) Int. Cl. G06Q 10/10; G06Q 50/00; G06Q 30/06; G06Q 30/04; G06T 17/00; G10L 15/30; G10L 15/18; G10L 15/22

(52) U.S. Cl. CPC G06Q 10/1095; G06Q 50/01; G06Q 30/0633; G06Q 30/04; G06T 17/00; G10L 15/30; G10L 15/18; G10L 15/22

(57) ABSTRACT

Embodiments relate to a method. The method comprises: communicating an invite for an event to a guest device; receiving at least one of a response and an event attending venue from the guest device in reply to the invite; automatically determining a first locale of a guest based on the event attending venue; automatically generating a purchase order for the guest based on the first locale, a second locale, and an input received from a host device; and automatically communicating the purchase order to a vendor at a predefined time prior to the event based on the first locale of the guest. The invite comprises at least one of event information, host information, guest information, activity information, budget information, vendor information, and reward information.

### FIELD OF THE INVENTION

This invention relates to a field of organizing events, and more particularly to a system and method for organizing virtual events and managing the events.

### BACKGROUND

“The ongoing pandemic disease has drastically transformed the way people interact socially with each other. In fact, governments and health experts around the globe strongly recommend for maintaining social distancing between each other, avoiding unwanted travel, restricting the number of people who can participate in any public events, etc. In the extreme cases the governments had to resort to strict quarantine measures to limit interactions between the people in the hopes of preventing the spread of the disease. It has become a new normal to maintain social distancing when people meet other i.e., no more handshakes and hugs. It is common to see people opting for elbow bumps and even foot shakes instead of handshakes. Also, people have avoided or cancelled all public gatherings including family functions, marriages, parties, etc. In fact, the authorities around the world have been strictly regulating the number of people who can participate in such gatherings even if it happens.

Further the fear of catching the disease has made people to avoid attending of any such events and people venture out of their homes only for essential needs. Due to the above, people started restoring to video calling facility to interact with each other for various occasions including day to day interactions with their loved ones, weddings, birthday parties, temple rituals, office meetings, online lectures, webinars, etc.

However, the video calling facility fulfils this need only partially as people will not be able to experience the closeness of meeting a person in real. Particularly when people participate in emotional events such as weddings through video call facility or any one-way live streaming options, the blessing of the couple cannot be done satisfactorily.” [Source: Patent application WO2021229286A1 titled “A system and method for providing virtual blessing using holographic telepresence is disclosed”, published on Nov. 18, 2021]

“The challenges of organizing real-world gatherings are much different from those of organizing online meetings. For example, to engage in online chat, there is no question of physical location, distance from home, availability of venue, or the like. All of the foregoing considerations and more, including intangibles such as social dynamics, make organizing real-world gatherings a more difficult and complex task.

Known Internet communication tools are insufficient for the task. In particular, email alone is inadequate because a person in one area has no organized way of approaching the problem of finding the identities and addresses of others in his area who are interested in a given topic and also interested in a topic-related meeting. Instant messaging and chat rooms alone are likewise inadequate for the same reasons.” [Source: U.S. Ser. No. 10/742,433B2 titled “Web-based interactive meeting facility, such as for progressive announcements”, published on Aug. 11, 2020]

There is a current need to address the shortcomings in the prior art and provide a system that convenes to enable to organize, create, manage orderings, and execute events. It would be advantageous to have an apparatus that considers at least some of the issues discussed above, as well as possibly other issues.

### SUMMARY

The present disclosure describes one or more aspects of event planning and management.

In an aspect a method is described herein. The method comprises: communicating, by a server, an invite for an event to a guest device; receiving, by the server, at least one of a response and an event attending venue from the guest device in reply to the invite; automatically determining, by the server using an artificial intelligence algorithm, a first locale of a guest based on the event attending venue; automatically generating, by the server using the artificial intelligence algorithm, a purchase order for the guest based on the first locale, a second locale at which the event is planned, and an input received from a host device; and automatically communicating, by the server, the purchase order to a vendor at a predefined time prior to the event based on the first locale of the guest. The invite comprises at least one of event information, host information, guest information, activity information, budget information, vendor information, and reward information. The purchase order comprises at least one of an item, a service, a delivery date, a delivery time, a mode of payment, a cap amount for the purchase order, a delivery instruction, and a delivery address.

In one embodiment, the event information comprises an event date, an event duration, an event timing, a periodicity of the event, an event title, an event agenda, an event venue image, an event type, and an event activity.

In another embodiment, the host information comprises details of a host, a host image, and a host locale, wherein the second locale comprises the host locale.

In another embodiment, the guest information comprises details of a guest, a guest image, and the first locale.

In yet another embodiment, the activity information comprises an action item to be performed for the event.

In yet another embodiment, the action item comprises at least one of presenting a media file, presenting a game, communicating an instruction, ordering food item and drinks, rendering a gift card, and rendering a return gift.

In yet another embodiment, the budget information comprises at least one of a total amount allocated for the event, and a cap amount for each guest.

In yet another embodiment, automatically determining, by the server using the artificial intelligence algorithm, the first locale of the guest based on the event attending venue comprises: determining, by the server using the artificial intelligence algorithm, a time for the guest at which the event is to be executed; and recommending, by the server using the artificial intelligence algorithm, at least one of the item, the service, and the purchase order.

In yet another embodiment, receiving, by the server, at least one of the response and the event attending venue from the guest device comprises: sending, by the server, an enquiry to a calendar module within the guest device; extracting calendar information from the guest device in reply to the enquiry, wherein the calendar information comprises an accepted meeting invite, a cancelled meeting invite, a tentative accepted meeting invite, and an unanswered meeting invite; and determining, by the server using the artificial intelligence algorithm, an availability of the guest based on the calendar information extracted from the guest device.

In yet another embodiment, the method further comprises: determining, by the server using the artificial intelligence algorithm, the event attending venue of the guest based on the calendar information extracted from the guest device.

In yet another embodiment, determining, by the server, using the artificial intelligence algorithm, the availability of the guest based on the calendar information extracted from the guest device comprises: receiving, by the server, at least one of the response and the event attending venue from the guest device comprises, upon determining the availability of the guest for the event and the event attending venue.

In yet another embodiment, the event comprises one of a physical event, a virtual event, and a hybrid event.

In yet another embodiment, the event comprises one of a planned event, and an instant event.

In another aspect, a method is described herein. The method comprises: receiving, by a server, an input from a host device; automatically analysing, using an artificial intelligence algorithm, the input received from the host device and extracting at least one of details of a vendor, and details of a service to be availed from the vendor for an event; establishing a communication to the vendor through an integration established between an application programming interface of the server and the vendor and automatically sending, by the server, an enquiry to the vendor regarding purchase of at least one of the service and an item; tracking an action item executed by a host for the event and estimating a first amount for the action item executed by the host, respectively; generating a first consolidated invoice for the host based on the first amount in a first home currency of the host. The input comprises at least one of event information, host information, guest information, activity information, budget information, an event agenda, vendor information, return gift information, and reward information.

In an embodiment, the event information comprises an event date, an event duration, an event timing, an event title, an event agenda, an event venue media file, an event type, and an event activity.

In another embodiment, the method comprises: analysing, by the server, using the artificial intelligence algorithm, the input received from the host device and extracting at least one of details of a guest, and the details of the service to be provided to the guest.

In another embodiment, the method comprises: automatically sending, by the server, an invite for the event to the guest based on at least one of the details of the guest, and the details of the service to be provided to the guest. The invite comprises at least one of the event information, the host information, the guest information, the activity information, the budget information, the event agenda, the vendor information, and the reward information.

In yet another embodiment, the method comprises: formulating, by the server, using the artificial intelligence algorithm, and scheduling the action item based on the event information and the activity information.

In yet another embodiment, formulating and scheduling the action item based on the event information and the activity information comprises: determining whether the vendor is involved in the action item; determining whether the integration is executed between the application programming interface of the server and the vendor; and notifying the host device whether there is the integration between the server and the vendor.

In yet another embodiment, the method comprises: automatically executing the action item at a predefined time prior to the event when the integration exists between the server and the vendor. The action item comprises at least one of a purchase of the item, rendering a gift card, participating in a game, ordering a food item, availing the service, communicating instructions, and processing a payment.

In yet another embodiment, the method comprises: executing the action item manually at a predefined time prior to the event when the integration does not exist between the server and the vendor. The action item comprises at least one of a purchase of the item, rendering a gift card, participating in a game, ordering a food item, availing the service, communicating instructions, and processing a payment.

In yet another embodiment, the method comprises: tracking the action item executed by a guest for the event separately; and estimating a second amount spent for the action item executed by the guest.

In yet another embodiment, the method comprises: generating a second consolidated invoice for the guest based on the second amount; and rendering the second consolidated invoice for the guest in a second home currency of the guest.

In yet another embodiment, the method comprises: estimating the first amount for the action item executed by the host comprises: tracking the action item executed by the guest; determining a second amount spent by the guest based on tracking the action item executed by the guest; comparing the second amount and a cap amount in the budget information; and calculating a difference in amount between the second amount and the cap amount as the first amount.

In yet another embodiment, the method comprises: generating a three-dimensional virtual model of an event venue as a virtual gallery using an event venue media file; populating virtually, by the server using the artificial intelligence algorithm, the three-dimensional virtual model of the event venue with the host and the guest; and performing a simulation using the three-dimensional virtual model to provide at least one of a virtual reality experience, an augmented reality experience, and a mixed reality experience of attending the event at the event venue in a real-time to the host and the guest.

In yet another embodiment, the method comprises: enabling the guest and the host to interact and communicate virtually in the virtual gallery.

In yet another embodiment, the method comprises: receiving a response, by the server, from the vendor upon sending the enquiry to the vendor; and notifying, by the server, a confirmation of the event to the host device based on the response received from the vendor.

In yet another embodiment, receiving the input from the host device comprises: receiving, by the server using a natural language processing algorithm, the input through a voice assistance device in at least one language in an audio format; and converting, by the server using the natural language processing algorithm, the input in the at least one language to a computer understandable format.

In yet another embodiment, the method further comprises: analysing, by the server using the artificial intelligence algorithm, the input received from the host device for a predefined time period; discovering, by the server using the artificial intelligence algorithm, at least one of a pattern and a behaviour of the host based on the analysis; recommending, by the server, a first predefined package to the host based on at least one of the pattern and the behaviour of the host analysed, wherein the first predefined package comprises at least one of the host information, the guest information, the activity information, the budget information, the event agenda, the vendor information, the return gift information, a guest, an additional guest list, and the reward information.

In yet another embodiment, the method further comprises: reminding, by the server using the artificial intelligence algorithm, the host, and the guest with a recurring notification at one or more predefined times prior to the event.

In yet another embodiment, the method further comprises: generating a second predefined package to the host based on the budget information; and recommending the second predefined package to the host.

In yet another embodiment, the method further comprises: recommending a food item for the event based on at least one of the pattern and the behavior of the host analysed.

In yet another embodiment, the method further comprises: recommending a return gift for the event based on at least one of the pattern, the behavior of the host analysed and the return gift trending in a market.

In yet another embodiment, the method further comprises: recommending an additional service to the host based on at least one of the pattern, the behavior of the host analysed and the type of the event.

In yet another embodiment, the method further comprises: automatically performing an audit on a previous history of the event planned and executed for a predefined period of time using a virtual robot; and recommending, using the artificial intelligence algorithm, a plan, a budget, and a strategy to the host based on the audit performed.

In yet another embodiment, the method further comprises: automatically analysing the action item executed and determining the item bought frequently; and recommending, using the artificial intelligence algorithm, the item based on the determination performed.

In yet another embodiment, the method further comprises: automatically analysing the action item executed and determining the vendor from where the item is bought frequently; recommending, using the artificial intelligence algorithm, the vendor based on the determination performed; and recommending, using the artificial intelligence algorithm, a premium account to the vendor.

In yet another embodiment, the method further comprises: automatically analysing the action item executed and determining the vendor from where the item is bought less; and notifying, using the artificial intelligence algorithm, the vendor to advertise on a digital media.

In yet another embodiment, the method further comprises: capturing a screenshot of at least one of the virtual reality experience, the augmented reality experience, and the mixed reality experience of the host and the guest attending the event at the event venue in the real-time; and rendering the screenshot to the guest and the host as a memory.

In yet another embodiment, the method further comprises: creating a user specified background of an event venue in a virtual gallery using an event venue media file; and populating virtually, by the server using the artificial intelligence algorithm, the user specified background of the event venue with the host and the guest.

In yet another aspect, a system is described herein. The system comprises a server comprising a memory, and a processor communicatively coupled to the memory. The processor is configurable to: communicate an invite for an event to a guest device; receive at least one of a response and an event attending venue from the guest device in reply to the invite; automatically determine, using an artificial intelligence algorithm, a first locale of a guest based on the event attending venue; automatically generate, using the artificial intelligence algorithm, a purchase order for the guest based on the first locale, a second locale at which the event is planned, and an input received from a host device; automatically communicate the purchase order to a vendor at a predefined time prior to the event based on the first locale of the guest. The invite comprises at least one of event information, host information, guest information, activity information, budget information, vendor information, and reward information. The purchase order comprises at least one of an item, a service, a delivery date, a delivery time, a mode of payment, a cap amount for the purchase order, a delivery instruction, and a delivery address.

In yet another aspect, a system is described herein. The system comprises a server comprising a memory, and a processor communicatively coupled to the memory. The processor is configurable to: receive an input from a host device; automatically analyse, using an artificial intelligence algorithm, the input received from the host device and extracting at least one of details of a vendor, and details of a service to be availed from the vendor for an event; establish a communication to the vendor through an integration established between an application programming interface of the server and the vendor; automatically send, by the server, an enquiry to the vendor regarding purchase of at least one of the service and an item; track an action item executed by a host for the event; estimate a first amount for the action item executed by the host, respectively; generate a first consolidated invoice for the host based on the first amount in a first home currency of the host. The input comprises at least one of event information, host information, guest information, activity information, budget information, an event agenda, vendor information, return gift information, and reward information.

In yet another aspect, a non-transitory storage medium is described herein. The non-transitory storage medium storing a sequence of instructions, which when executed by a processor: communicates an invite for an event to a guest device; receives at least one of a response and an event attending venue from the guest device in reply to the invite; determines, using an artificial intelligence algorithm, a first locale of a guest based on the event attending venue; generates, using the artificial intelligence algorithm, a purchase order for the guest based on the first locale, for a second locale at which the event is planned, and for an input received from a host device; and automatically communicates the purchase order to a vendor at a predefined time prior to the event based on the first locale of the guest. The invite comprises at least one of event information, host information, guest information, activity information, budget information, vendor information, and reward information. The purchase order comprises at least one of an item, a service, a delivery date, a delivery time, a mode of payment, a cap amount for the purchase order, a delivery instruction, and a delivery address.

In yet another aspect, a non-transitory storage medium is described herein. The non-transitory storage medium storing a sequence of instructions, which when executed by a processor causes the processor to: receive an input from a host device; automatically analyze, using an artificial intelligence algorithm, the input received from the host device and extracting at least one of details of a vendor, and details of a service to be availed from the vendor for an event; establish a communication to the vendor through an integration established between an application programming interface of a server and the vendor; send, by the server, an enquiry to the vendor regarding purchase of at least one of the service and an item; track an action item executed by a host for the event; estimate a first amount for the action item executed by the host, respectively; generate a first consolidated invoice for the host based on the first amount in a first home currency of the host.

The input comprises at least one of event information, host information, guest information, activity information, budget information, an event agenda, vendor information, return gift information, and reward information.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the descriptions that follow.

### BRIEF DESCRIPTION OF THE FIGURES

In the present disclosure, reference is made to the accompanying drawings, which form a part hereof. In the drawings, similar symbols typically identify similar components, unless context dictates otherwise. Various embodiments described in the detailed description, and drawings, are illustrative and not meant to be limiting. Other embodiments may be used, and other changes may be made, without departing from the spirit or scope of the subject matter presented herein. It will be understood that the aspects of the present disclosure, as generally described herein, and illustrated in the Figures, can be arranged, substituted, combined, separated, and designed in a wide variety of different configurations, all of which are contemplated herein. The embodiments are illustrated by way of example and not limitations in the accompanying drawings, in which like references indicate similar elements and in which:

FIG. 1 is showing an integration of a plurality of application programming interfaces in the system, according to one or more embodiments.

FIG. 2 illustrates an application hosting diagram, according to one or more embodiments.

FIG. 3 is showing a system components integration, according to one or more embodiments

FIG. 4A is depicting a technical process flow of authentication of a user using the system, according to one or more embodiments.

FIG. 4B is depicting a technical process flow of viewing all planned events, according to one or more embodiments.

FIG. 5A is depicting a technical process flow of event creation via a client application interface by the system, according to one or more embodiments.

FIG. 5B is depicting a technical process flow for voice command-based event planning and execution by the system, according to one or more embodiments

FIG. 6 is showing a graphical user interface (GUI) for the user of the event planning system, according to one or more embodiments.

FIG. 7 is showing a progress in workflow and context-based display and collection of event related information for the event details tab during the planning of an event using the system, according to one or more embodiments.

FIG. 8 is showing the progress in workflow and context-based display and collection of event related information for the select attendees tab during the planning of an event using the system, according to one or more embodiments.

FIG. 9 is showing a progress in workflow and context-based display and collection of event related information for the food and drinks tab during the planning of an event using the system, according to one or more embodiments.

FIG. 10 is showing a progress in workflow and context-based display and collection of event related information for the games tab during the planning of an event using the system, according to one or more embodiments.

FIG. 11 is showing a progress in workflow and context-based display and collection of event related information for the return gifts tab during the planning of an event using the system, according to one or more embodiments.

FIG. 12 is showing a progress in workflow and context-based display and collection of event related information for review and the confirm tab during the planning of an event using the system, according to one or more embodiments.

FIGS. 13a and 13b shows payment related information, according to one or embodiments.

FIG. 14 shows current events that are in the planning stage, according to one or more embodiments.

FIG. 15 shows an invitation summary that is sent to the guest or an invitee, according to one or more embodiments.

FIG. 16 shows the event interface, where the host and guests interact virtually, according to one or more embodiments.

FIG. 17A shows an invoice summary generated, by the server, for the host, according to one or more embodiments.

FIG. 17B shows the itemized details of the invoice, according to one or more embodiments.

FIG. 18 is showing a process flow of event creation using the system, according to one or more embodiments.

FIG. 19 is showing a process of searching for restaurants via the system, according to one or more embodiments.

FIG. 20 is depicting a technical process flow for accepting, by the guest, an event via the system, according to one or more embodiments.

FIG. 21 is showing a process flow of an artificial intelligence and machine learning-based module of the event planning system, according to one or more embodiments.

FIG. 22 is a block diagram showing a robotic process automation module for sets of virtual event applications for a category of task, using the system according to one or more embodiments.

FIG. 23 is showing an automation process by the robotic process automation module of the system, according to one or more embodiments.

Other features of the present embodiments will be apparent from the accompanying drawings and from the detailed description that follows.

### DETAILED DESCRIPTION

### Definitions and General Techniques

For simplicity and clarity of illustration, the drawing figures illustrate the general manner of construction. Descriptions and details of well-known features and techniques may be omitted to avoid unnecessarily obscuring the present disclosure. The dimensions of some of the elements in the figures may be exaggerated relative to other elements to help improve understanding of the embodiments of the present disclosure. The same reference numeral in different figures denotes the same elements.

Although the following detailed description contains many specifics for the purpose of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only and is not intended to be limiting. Unless defined otherwise, all technical and scientific terms used herein have the same meaning as commonly understood by one with ordinary skill in the art to which this disclosure belongs.

The articles “a” and “an” are used herein to refer to one or to more than one (i.e., to at least one) of the grammatical object of the article. By way of example, “an element” means one element or more than one element.

The terms “first”, “second”, “third”, and the like in the description and in the claims, if any, are used for distinguishing between similar elements and not necessarily for describing a particular sequence or chronological order. It is to be understood that the terms so used are interchangeable under appropriate circumstances such that the embodiments described herein are, for example, capable of operation in sequences other than those illustrated or otherwise described herein. Furthermore, the terms “include”, “have”, and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left”, “right”, “front”, “back”, “top”, “bottom”, “over”, “under” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein should be construed as critical or essential unless explicitly described as such. Furthermore, as used herein, the term “set” is intended to include items (e.g., related items, unrelated items, a combination of related items and unrelated items, etc.), and may be used interchangeably with “one or more”. Where only one item is intended, the term “one” or similar language is used. Also, as used herein, the terms “has”, “have”, “having”, or the like are intended to be open-ended terms. Further, the phrase “based on” is intended to mean “based, at least in part, on” unless explicitly stated otherwise.

It should be understood that the terms “system,” “device,” “unit,” and/or “module” are used in this disclosure to refer to a different component, portion, or component of the different levels of the order. However, if other expressions may achieve the same purpose, these terms may be replaced by other expressions.

The terms “couple”, “coupled”, “couples”, “coupling”, and the like should be broadly understood and referred to as connecting two or more elements mechanically, electrically, and/or otherwise. Two or more electrical elements may be electrically coupled together, but not be mechanically or otherwise coupled together. Coupling may be for any length of time, e.g., permanent, or semi-permanent or only for an instant. “Electrical coupling” includes electrical coupling of all types. The absence of the word “removably”, “removable”, and the like near the word “coupled”, and the like, does not mean that the coupling, etc. in question is or is not removable.

As defined herein, two or more elements or modules are “integral” or “integrated” if they operate functionally together. As defined herein, two or more elements are “non-integral” if each element can operate functionally independently.

As defined herein, “real-time” can, in some embodiments, be defined with respect to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All variations which come within the meaning and range of equivalency of the claims are to be embraced within their scope.

As defined herein, “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Unless otherwise defined herein, scientific, and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of, embodiments herein, and other related fields described herein, are those well-known and commonly used in the art.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Even though particular combinations of features are disclosed in the specification, these combinations are not intended to limit the disclosure of possible implementations.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

An initial overview of technology embodiments is provided herein, and specific technology embodiments are then described in further detail. This initial summary is intended to aid readers in understanding the technology more quickly but is not intended to identify key or essential technological features, nor is it intended to limit the scope of the claimed subject matter.

The embodiments herein and the various features and advantageous details thereof are explained more fully with reference to the non-limiting embodiments that are illustrated in the accompanying drawings and detailed herein.

In order to fully understand the scope of the invention, the following terms used herein are hereby defined.

The following terms and phrases, unless otherwise indicated, shall be understood to have the following meanings.

As used herein, the term “locale” refers to a time zone, place, and/or a locality where an event is to be executed. The locale can be set or provided as an input by the user via the system.

As used herein, the term “event information” refers to any information related to the planning and management of an event. The event information comprises at least one of an event date, an event duration, an event timing, a periodicity of the event, an event title, an event agenda, an event venue image, an event type, an event activity, etc.

As used herein, the term “host information” refers to any information related to a host. The host information comprises details of a host, a host image, and a host locale.

As used herein, the term “guest information” refers to any information related to a guest. The guest information comprises details of a guest, a guest image, and the guest locale.

As used herein, the term “activity information” refers to any information related to an action item to be performed for the event. The action item comprises at least one of presenting a media file, presenting a game, playing online games, communicating an instruction, rendering a gift card, and rendering a return gift.

As used herein, the term “budget information” refers to budget allocated by a host for the event. The budget information comprises at least one of a total amount allocated for the event, and a cap amount for each guest. The budget information may also comprise a cap amount for each guest in the home currency of the guest.

As used herein, the term “vendor information” refers to any information related to a vendor. The vendor information comprises details of a vendor, a purchase amount for that vendor, a list of items to be purchased from the vendor, etc.

As used herein, the term “event date” refers to a date at which the event is to be executed.

As used herein, the term “event timing” refers to a timing at which the event is to be executed. The event timing comprises a start time and an end time. The start time and the end time may be provided in the locale at which the event is planned. The system is capable of converting the time zone as per the guest locale and notify the guest.

As used herein, the term “periodicity of the event” refers to details regarding frequency of happening of the event. For example, the “periodicity of the event” may provide details such as recurring event, or a one-time event. Birthday parties may be recurring events every year on the same date, while the retirement function may be a one-time event.

As used herein, the term “event attending venue” refers to a locale, and/or an address from which guest/host will attend the event.

As used herein, the term “calendar information” refers to details comprising past, present, and upcoming events in the user's calendar. The calendar information comprises accepted meeting invites, cancelled invites, and pending invites, etc.

As used herein, the term “event” could refer to a meeting that involves people to meet and chat regarding any matter. The event could be related to at least one of fun activities, a professional meeting, an alumni meeting, a colleagues meeting, a parent's teacher meeting, a birthday party, a retirement function, a celebration, an online-gaming activity presentation, etc.

As used herein, the term “planned event” refers to any event that is previously planned and scheduled to be executed. The system sends the invitations to the respective guests and executes the event at the scheduled date as planned. The guest may RSVP the invite for attending the event.

As used herein, the term “instant event” refers to an event that is to be executed instantly without any prior plan.

As used herein, the term “virtual event” refers to any event that is to be executed virtually. The virtual event may be a virtual meeting where the guest and the host meet virtually through digital media (e.g., video conferencing, etc.). It may further include physical elements such as food, gifts, delivered during the virtual event.

As used herein, the term “physical event” refers to any event where the guest and the host attend the event physically at a particular place.

As used herein, the term “hybrid event” refers to any event where at least part of the guest and the host attend the event physically while the other attend virtually through video conferencing.

As used herein, “cyber security” is the application of technologies, processes, and controls to protect systems, networks, programs, devices, and data from cyber-attacks.

In some embodiments, the system is referred to as FUNTARO® a platform on which the system is implemented.

In yet another aspect, a system is described herein. The system comprises a server comprising a memory, and a processor communicatively coupled to the memory. The processor is configurable to communicate an invite for an event to a guest device; receive at least one of a response and an event attending venue from the guest device in reply to the invite; automatically determine, using an artificial intelligence algorithm, a first locale of a guest based on the event attending venue; automatically generate, using the artificial intelligence algorithm, a purchase order for the guest based on the first locale, a second locale at which the event is planned, and an input received from a host device; and automatically communicate the purchase order to a vendor at a predefined time prior to the event based on the first locale of the guest. The invite comprises at least one of event information, host information, guest information, activity information, budget information, vendor information, and reward information. The purchase order comprises at least one of an item, a service, a delivery date, a delivery time, a mode of payment, a cap amount for the purchase order, a delivery instruction, and a delivery address.

In yet another aspect, a system is described herein. The system comprises a server comprising a memory, and a processor communicatively coupled to the memory. The processor is configurable to receive an input from a host device; automatically analyse, using an artificial intelligence algorithm, the input received from the host device and extract at least one of details of a vendor, and details of a service to be availed from the vendor for an event; establish a communication to the vendor through an integration established between an application programming interface of the server and the vendor and automatically send, by the server, an enquiry to the vendor regarding purchase of at least one of the service and an item; track an action item executed by a host for the event and estimate a first amount for the action item executed by the host, respectively; and generate a first consolidated invoice for the host based on the first amount in the first home currency of the host. The input comprises at least one of event information, host information, guest information, activity information, budget information, an event agenda, vendor information, return gift information, and reward information.

In yet another aspect, a non-transitory storage medium is described herein. The non-transitory storage medium storing a sequence of instructions, which when executed by a processor: communicates an invite for an event to a guest device; receives at least one of a response and an event attending venue from the guest device in reply to the invite; automatically determines, using an artificial intelligence algorithm, a first locale of a guest based on the event attending venue; automatically generates, using the artificial intelligence algorithm, a purchase order for the guest based on the first locale, a second locale at which the event is planned, and an input received from a host device; and automatically communicates the purchase order to a vendor at a predefined time prior to the event based on the first locale of the guest. The invite comprises at least one of event information, host information, guest information, activity information, budget information, vendor information, and reward information. The purchase order comprises at least one of an item, a service, a delivery date, a delivery time, a mode of payment, a cap amount for the purchase order, a delivery instruction, and a delivery address.

In yet another aspect, a non-transitory storage medium is described herein. The non-transitory storage medium storing a sequence of instructions, which when executed by a processor cause: receiving an input from a host device; automatically analysing, using an artificial intelligence algorithm, the input received from the host device and extracting at least one of details of a vendor, and details of a service to be availed from the vendor for an event; establishing a communication to the vendor through an integration established between an application programming interface of a server and the vendor and automatically sending, by the server, an enquiry to the vendor regarding purchase of at least one of the service and an item; tracking an action item executed by a host for the event and estimating a first amount for the action item executed by the host, respectively; and generating a first consolidated invoice for the host based on the first amount in a first home currency of the host.

The input comprises at least one of event information, host information, guest information, activity information, budget information, an event agenda, vendor information, return gift information, and reward information. In an embodiment, the event information comprises an event date, an event duration, an event timing, an event title, an event agenda, an event venue media file, an event type, and an event activity.

During this digital era, as well as the COVID 19 Pandemic, Virtual Events become a new trend. People are meeting using the several video conferencing software's and food delivery apps. There is no specific application in the market which can provide complete end to end operations for the virtual event.

Due to the pandemic, and going forward, the corporate work culture is changing directions towards remote work or a hybrid working culture. Team building is going to be a major challenge and it requires an application for the teams to frequently meet.

The present system and method provide a complete end to end virtual event platform where customers can host an event, attend the event, order food and drinks and play several virtual games during the event. A host can provide gifts to the guests and guests can give gifts to the hosts. In an embodiment, for physical events, hosts can log in for sending invitation to guests and order all the items required for the physical event like ordering food catering, cakes, decorative items, return-home gifts, etc. Further, to make the host/user life easier, the present system provides packages which make the event planning process simple and efficient.

Technical Problem: Currently there is no existing application or software which will handle the complete end to end (all functionalities that are required) event while organizing a virtual event or hybrid event on one platform. Also, providing a single invoice to the host makes the accounting process easy for corporations or individuals. A software application which handles the end-to-end operations is required to organize virtual events or hybrid events, and it also covers different types of events like corporate happy hours, family and friends get togethers, play dates, birthday parties and so on.

Technical Solution: The present system is built to connect people from all over the world where people are in different locales (e.g., comprising different time zones). The system is built to accommodate the needs of corporations and different cultures all over the world by considering their locale. In an embodiment, the system may be used for physical event arrangements as well. It is an all-in-one platform.

In an embodiment, the system comprises different modules for sending electronic invitations, video conferencing, virtual games, ordering food and drinks online, and ordering or presenting gifts to host or guests online (e-commerce). For each individual module, there may be dedicated applications. The system is the one stop solution which provides access to multiple applications which integrate to book the orders. On top of that, the system provides one invoice for all the orders which makes the corporations or individuals life so easy, by providing a single invoice comprising all the details, which will avoid a lot of paperwork and process for approvals and reimbursements.

In an embodiment, the system provides all the functionalities needed for an event 1) video conferencing tools (like Zoom®, Teams®, Webex®, Skype® etc.) 2) food delivery tools (For example, Uber Eats®, and so on) 3) E-commerce websites (retail e-commerce, gift card resellers) 4) online games 5) invitations (e.g.; Evite.com®).

The system provides a one stop shop for all the end-to-end event needs without anyone stepping out from home (except to perhaps open your door to receive your lunch via delivery). One can plan an event within no time from a computer (Web app) or phone (mobile App). Virtual events (that include food, drinks, gifts, and online games) maintain one invoice for all the expenses which makes archiving, and reimbursement, for the event very easy.

User can plan any physical event, virtual event and hybrid event using the application. The system further enables the user to plan an instant event. The main elements of the event may be video conferencing, food and drinks ordering, playing online games, exchanging gifts, and receiving gifts as rewards for the game winners. The system provides all the features an event needs in one application. The customer can access the system using the application through the Web (internet) or a mobile application.

No conventional application exists that encompasses all features. Currently, a user has to access multiple applications separately to fulfil the need for event planning. In an embodiment, corporate companies, public users, kids, family, and friends can use the application for planning events and celebrating them. In the current applications available in the marketplace, one cannot have all the technical infrastructure required (features) for the end-to-end virtual event. With today's existing applications, a human has to go to individual applications for video, for food and drinks to host and guest, exchanging gifts, return gifts, gifts to host, rewards for the game winners, and playing games online.

Today's existing solutions make the user access multiple applications with individual user accounts for each application to organize an event, which is time consuming. The claimed system provides a seamless workflow to handle all the needs of organizing an event in one application. The system takes care of all the back end for the event success.

Now a days, companies are hosting virtual happy hours, but their employees must eat and drink their own food and beverages. Unlike physical parties, in virtual meetings, it is hard for people to have team building activities and one on one discussions in one platform. The claimed system provides an end-to-end virtual event, including online games which will help the team to do team building activities.

Even due to the current or after COVID-19 pandemic situations, with lock down and stay at home conditions, it is very hard to host. attend, or to arrange meetups/parties. Due to the flight and visa restrictions in the USA and all other countries, people are not taking risks to travel to home countries to get married. Instead of having fat weddings, they are getting married abroad. All the family and friends are missing the major events, but with the present system, no one will miss a single event. People can host parties from anywhere in the world. The system is also capable of creating memories for the events conducted with the guests from all over the world.

Hosting a physical party is always expensive and time consuming. Anywhere in the world, all the major metropolitan cities and Tri-states, traffic conditions and distance to travel is a common problem. Drink and drive is never a good idea but sometimes when you have good company, you never want to stop with a few drinks. Now a days everybody is leading a busy life. Sometimes, it is very hard to travel and attend an event/party/happy hour/spending time with a best friend or a family member. It is a very common issue in today's world that happens to all of us.

In such example scenarios, the present system and method is one of the solutions to your problem. The present system enables the users to meet virtually, order online and deliver food and drinks, video conference and chat with your company.

Technical Details: The system comprises a multi-layered system architectural model that specifies connections across all the resources corresponding to at least the subset of the number of resources, and an environment definition specifies configuration requirements of at least the subset of the number of resources in the target environment. In accordance with the execution of the configuration engine, the non-transitory medium also includes instructions to build a baseline configuration and a policy for at least the subset of the number of resources in accordance with the environment definition, to build a second metadata for at least the subset of the number of resources in accordance with the policy for the second metadata providing a number of contexts to the environment definition, and version, in a repository of the computing system, the environment definition, the baseline configuration, the policy, the second metadata, and a test instruction pertinent to scanning the target environment for configurations.

Delivery (Cl/CD) pipelines: It runs enterprise vulnerability scans, and the results repositories may include the results of scanning for security vulnerabilities via an analytics and visualization engine. Enterprise Cl/CD pipelines may enable automating software delivery processes, including combining code changes in a central repository and deploying to desired environments, the aforementioned scans may be integrated with enterprise Cl/CD pipelines. The platform is designed to distribute applications to take full advantage of living in the cloud, to run globally, avoid bottlenecks, and always be available for users worldwide. This supports the applications to be coupled and decoupled and helps achieve auto scale.

Virtual Reality based Experience: The system offers a 3D virtual model of an event, such as a wedding or a sporting event, and for sharing the event with one or more virtual attendees. Virtual attendees connect to the experience platform to view the 3d virtual model of the event using virtual reality glasses, i.e., a head mounted display, from a virtual gallery, preferably from a user selected location and orientation, or a common location and orientation for all virtual attendees. In one form, the virtual attendees can see and interact with other virtual attendees in the virtual gallery. In an embodiment, the platform on which the application is deployed or used, may further include an augmented reality service, a location-determining service, Global Positioning System (GPS) based service, product-ordering service, e-commerce (like sending transportation tickets for an event) service, party supply service, event management service, to serve as a one stop shop kind of platform.

The three-dimensional virtual model creation is described below: In an embodiment, the system generates a three-dimensional virtual model of an event venue as a virtual gallery using an event venue media file. The system then populates virtually, by the server using the artificial intelligence algorithm, the three-dimensional virtual model of the event venue with the host and the guest. The system then performs a simulation using the three-dimensional virtual model to provide at least one of a virtual reality experience, an augmented reality experience, and a mixed reality experience of attending the event at the event venue in a real-time to the host and the guest. The system via the three-dimensional virtual model enables the guest and the host to interact and communicate virtually in the virtual gallery.

The system is also capable of automatically capturing a screenshot of at least one of the virtual reality experience, the augmented reality experience, and the mixed reality experience of the host and the guest attending the event at the event venue in the real-time, and rendering the screenshot to the guest and the host as a memory. In an embodiment, the system is capable of creating a user specified background of an event venue in a virtual gallery using an event venue media file. The system can also populate virtually the user specified background of the event venue with the host and the guest and render to the guest and the host as a memory.

Artificial Intelligence and Machine Learning: The system is robust to convert the data into value-adding insights, and leverages machine learning to predict the next event or suggestions on the restaurant or suggestions on gifts by analysing all of the available information and creating an intelligence to fulfil success and needs in future events.

Artificial intelligence (AI) is a collection of many different technologies working together to enable machines (including software) to sense, grasp, act, and learn with human-like levels of intelligence. Technologies like machine learning and natural language processing, which are part of the AI landscape, will be used to make the application an intelligent one. Each one of the technologies, when applied in combination with data, analytics, and automation, can help businesses achieve their goals, be it by improving customer service or optimizing the supply chain or marketing strategies or automated voice assistance or image recognition and so on.

Machine Learning (ML): Machine Learning is a type of artificial intelligence that enables systems to learn patterns from data and subsequently improve future experiences. In an embodiment, AI is used in digital assistance, applications that analyse data to optimize a given business function.

Artificial intelligence is used in several ways in the present system. In an embodiment, the platform may be integrated with Natural Language Processing (NLP) platforms (for example, Alexa®, Sint and Google Home® or Google Eco®) to plan an event through voice assistance which can be considered as the NextGen of Event planning. In an embodiment, the NLP can be an inbuilt module or may involve an integration with products from Amazon®, Google® and Apple®.

In an embodiment, the system receives the input from the host device. The system receives the input, using a natural language processing algorithm, through a voice assistance device in at least one language in an audio format. The system then converts, using the natural language processing algorithm, the input into at least one language of a computer understandable format.

The system then analyses, using the artificial intelligence algorithm, the input received from the host device for a predefined time period. The system then discovers, using the artificial intelligence algorithm, at least one of a pattern and a behavior of the host based on the analysis. The system then recommends a first predefined package to the host based on at least one of the pattern and the behavior of the host analysed. The first predefined package comprises at least one of the host information, the guest information, the activity information, the budget information, the event agenda, the vendor information, the return gift information, a guest, an additional guest list, and the reward information.

In an embodiment, the system reminds the host, and the guest for a recurring event at a predefined time prior to the event based on the recurring event details with the input using AI. In another embodiment, the system generates a second predefined package to the host based on the budget information, and recommends the second predefined package to the host. In yet another embodiment, the system recommends a food item for the event based on at least one of the pattern and the behavior of the host and guests analysed. In yet another embodiment, the system recommends, using AI, a return gift for the event based on at least one of the pattern, the behavior of the host or guests analysed and the return gift trending in a market. In yet another embodiment, the system recommends, using AI, an additional service to the host based on at least one of the pattern, the behavior of the host and guests analysed and the type of the event.

In yet another embodiment, the system automatically performs, using AI, an audit on a previous history of the event planned and executed for a predefined period of time using a virtual robot. The system then recommends, using the artificial intelligence algorithm, a plan, a budget, a strategy to the host based on the audit performed.

In yet another embodiment, the system automatically analyses the action item executed and determines the item bought frequently. The system then recommends, using the artificial intelligence algorithm, the item based on the determination performed.

In yet another embodiment, the system automatically analyses the action item executed and determines the vendor from where the item is bought frequently. The system then recommends, using the artificial intelligence algorithm, the vendor based on the determination performed. The system is also capable of recommending, using the artificial intelligence algorithm, a premium account to the vendor. In yet another embodiment, the system also automatically analyses the action item executed and determines the vendor from where the item is bought less. The system then notifies, using the artificial intelligence algorithm, those vendors to advertise on a digital media.

The system is also capable of recommending predefined packages using AI. During event planning, based on customer/user previous usage or orders or interests or browsing history, the system will recommend the predefined packages to the customers which will make the event planning process quick and easy for the user. During event planning, while adding the guest list, based on the previous similar events hosted by the customer, the system, using AI analysis, recommends the list of guests from the previously invited lists/groups.

Based on the customer or customer family members' recurring events like birthdays, anniversaries or any similar special day or special occasion, the system reminds or recommends the customer to host an event.

Once the system completes the customer acquisition, using AI, based on all the users' preferences and interests, the system, using AI, generates common standard packages and starts recommending the customers to improve the revenue as well as helping the customer to plan an event within no time.

During the event planning depending on event type and number of guests, the system, using AI, analyses and recommends the Host with a list of return gifts related to that event and the customer's previous orders in the database. While ordering food by user (host or guest), based on previous orders in the database as well as their browsing history, the system recommends their favourite food order. Gifts for guests, based on the previous orders and popularity or trends in the market, the system recommends the choices for guest giving ‘Gift to Host’.

Depending on the event type and user interests (again according to the previous usage data and browsing history), the system, using AI, recommends the additional services to the user. The system performs all the audit processes, like nightly, weekly, monthly, quarterly, semi-annually, and yearly with Virtual BOTs for the accuracy and to help the financial team make better decisions.

Further, using AI, the system determines those products or services which attracted more users and corporate strategies accordingly. On the corporate side of business, based on the bestselling products or services, the system, using AI, identifies the list of users and recommends strategies, like premium accounts, for them to improve their revenue and profits.

On the Corporate side of business, based on the lowest business making users, the system identifies the list of those users and recommends them to do advertisements and to increase the advertisement revenue as well as to improve the users (e.g., vendors) business.

Cyber Security: Cyber security is the protection of Computer systems and networks from information disclosure, theft of, or damage to hardware, software, or electronic data, as well as protection from the disruption or misdirection of the services they provide.

In the present world, due to the Digital transmission, internet, and cloud expansion, implementing cyber security is a critical action for every enterprise or organization to safeguard their business and customers and their personal data from malicious attacks/hackers.

Cybersecurity has a primary goal to ensure the system's dependability, integrity, and data privacy.

The major implementation as per the business plan is, every user (host or guest) has to register with a valid email ID and verification to ‘Plan an Event’ or even to ‘Attend an Event’ which will provide the security to ensure that unauthorized users cannot attend the event and cannot perform data breaches.

Security measures may be required for logging into an account using voice-assistance devices like Alexa®, Google Home® and Siri®, etc.

Security measures are taken to protect the users and vendors personal information (PI).

To protect the users, the system encrypts the gift card numbers when displaying the gift card details in the applications. To gain the user confidence, the system provides the third-party login, like using Google® account or Facebook® account. to use the gift card.

The system sets all the security controls in place for the users while they play online games.

Vendors: During the online sign up, the system takes a lot of precautions to avoid spam or BOT registrations in the third-party sign-up workflow.

The system ensures the application is PCI-compliant and continues to meet the security needs of the payments industry.

The system implements Cross-Operation Resource Sharing, CORS, to enable controlled access to resources outside the domain.

The system practices measures taken for the Users Passwords Protection.

Encryption: In an embodiment, SSL/TLS encryption is possible because of the public-private key pairing that SSL certificates facilitate. Clients (such as web browsers) get the public key necessary to open a TLS connection from a server's SSL certificate.

Authentication: SSL certificates verify that a client is talking to the correct server that actually owns the domain. This helps prevent domain spoofing and other kinds of attacks.

HTTPS: Most crucially for businesses, an SSL certificate is necessary for an HTTPS web address. HTTPS is the secure form of HTTP, and HTTPS websites are websites that have their traffic encrypted by SSL/TLS 1.3/1.2 protocol. This system employs HTTPS.

In addition to securing user data in transit, HTTPS makes sites more trustworthy from a user's perspective.

Creating an Event/Host inputs: Once the system enables the user to complete the registration, the system enables the user to organize a planned event or instant event. The system also enables the user to create a physical event or virtual event. If it is an instant event, it is just going to be only like the video conference and playing games. The system enables the user (e.g., guest, host) to eventually order food while they are doing the instant event. The system enables the user to provide event name, even date, time, and what time zone the event is going to be in. The system also enables the host to provide the list of guests and sponsors during the event. The system has an AI module which is aware of traditional cultural values of the host and guests. For example, the host in India always sponsors food for guest who are attending the event. Whereas in the western world, even when the host is hosting, the guests may have to pay for all of them, or everybody pays on their own. The system is built considering at least one of a Western culture, an Asian, and Eastern culture, and so on. The system enables the host to provide the sponsoring amount for this event. The system enables the host to provide an amount per invitation, a return gift, any games added to the event, gift for the winner to make the event interactive and successful.

Creating Memories: The system enables a user to create a picture combining all the participants with a virtual background. The system shares the picture to the host for the approval and, upon confirmation from the host, the system shares it with the guests.

The system is configured to create memories, especially for participants living in different countries. The system is configured to create memories based on the terms and conditions of the locale of the event attending venue or host venue.

Multiple Hosts: The system also enables multiple hosts to manage the event. The system also enables to have an anchor as a co-host in addition to the host. The co-host could be a celebrity, like a college student or like an entertainer.

The present invention solves the problems of technical glitches. So, for example, the host is hosting an event, and everybody is able to join the event at the real time except for a first user. The first user may then be able to join once the technical glitch is solved. The system provides buffered videos available to the first user. The system enables the first user to act as a guest at least for a few moments and registers that the guest has attended the event. The host may notice the attendance and provide a return gift for that particular period of time.

The system comprises a cybersecurity module that enables the login of the user from multiple devices. For example, if the user's laptop is not starting or the host wants to connect from a mobile, the host should login from the phone. The system automatically logs out the user from the previous system. The system also enables the user to launch a website and log in to access the system. The system also keeps track of the IP address of the user to forecast any counterfeit activities and to restrict any unauthorized access or entry for the event.

Reminders and Recurring Events: The system, using AI, based on user's pre usage of the data, such as event title, event date, time, and orderings, can recommend recurring recommendations to the host. The system sends a reminder at a predefined time prior to the event to plan the event. The system also recommends packages based on the prior history of user behavior or pattern. The system can also recommend cap amount, budget, etc. The system can also recommend packages based on trend in the market and choices made by people of similar behavior. The system, using AI, recommends the predefined package, and the user can choose the package via a few clicks. The system can also choose the contact list suggested or recommended by the system.

Invoice generation: The system enables the host to plan an event and have guests from all over the world. The guests may be from India, Canada, Mexico, etc. The system analyses the input received from the host and the response from the guests from the invite sent. The system then determines the number of guests from each locale. The system then receives, from the host, a cap amount for each guest in each locale and the total budget information. The host may provide the budget information and the cap amount for each guest in each locale.

For example, the host may provide $50 for a US guest and 5000 rupees for a guest from India. The system executes the action item and makes the purchase by communicating a purchase order to the third-party vendor. The system keeps track of the action item executed by the host and determines an amount spent by the host. The system converts the billing amount in the home currency of the host. The system generates a single consolidation for all purchases even when making purchase from multiple vendors. The system also keeps track of the difference in the amount spent by the guest instead of the cap amount allotted for that guest. The system also generates a consolidated invoice for the guest in the home currency of the guest. The system also tracks the return gifts sponsored by the host and bills the host accordingly in the home currency of the host.

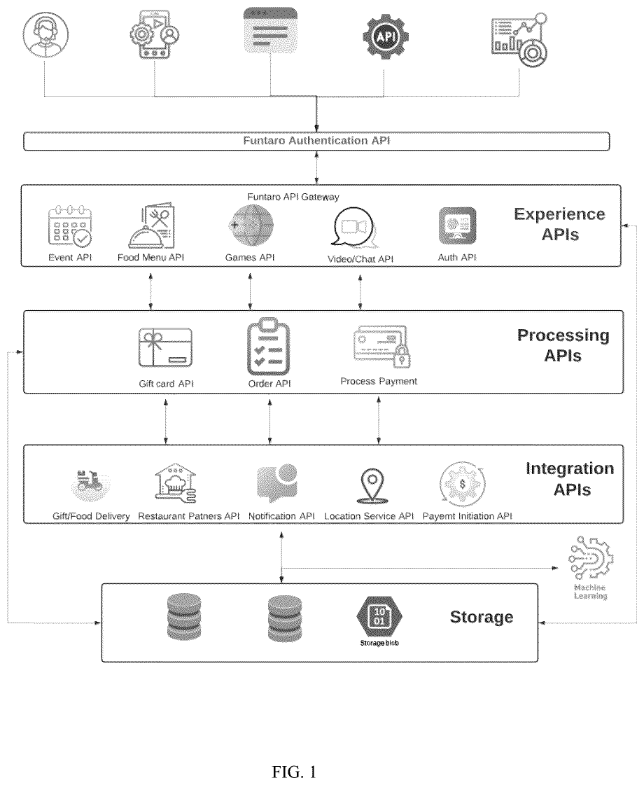

FIG. 1 is showing an integration of a plurality of application programming interfaces in the system, according to one or more embodiments. The integration architecture diagram comprises an experience API, processing API, and an integration API. The notations of all those shown in the figures are the customer services like the event application or customer service application. The user may use the customer services from a mobile device and/or web application. The system also enables the user to end up leveraging its own API's. Any request that comes to the API's are processed. An API is broken down into three kinds as mentioned above. Any requests that come to an API has to go to the first endpoint, the authentication gateway API. The Gateway API is a place where the system authenticates the request to make sure the request is coming from a valid source and whether the incoming request is even valid. The request has a token. The system then checks for token validity. The functionality of the gateway authentication is rigorous, in which it authenticates and authorizes to make sure each request is actually valid. The gateway API is the only API that will be exposed to the internet world. The other API rests in the resource group and is not exposed to the internet for security reasons.

Experience API is an API that contains the video conference API, games API, etc., for processing an event API. So, each API takes care of its own functionality, like events API, for example. Event API is responsible for anything regarding an event, like to create an event, update an event, share an event, etc. Food API is responsible to bring all the food related stuff. Games API is responsible for any game related activities in the event.

The processing API comprise the gift card API, and the payment processing API. The processing API is responsible for taking the payments and authorizing the payments. The processing API is responsible for taking a card number and then tokenizing the card number and providing authorization tokens which are used for successful payment processing. The authorized token is used to actually process the payment when everything is done.

Order API is responsible for sending orders in real time to the restaurants or for communicating orders based on the restaurant's configuration. Restaurants may have in-house API's. The system may send real time order messages to the restaurants. The architecture may also enable integration with third party vendor API. Location API is used for detecting the location, and communicate location, regarding vendors, offers, etc. Notification API is responsible to send alerts, reminders, invoice, etc. The above-mentioned APIs provide different services as illustrated above. The data extracted can be used for machine learning and analysis purposes.

For instance, the system is capable of executing an action item upon the planning and confirmation of the event. In an embodiment, the system receives a response from the vendor upon sending the enquiry to the vendor, and notifies a confirmation of the event to the host device based on the response received from the vendor. The system automatically executes the action item by itself. The system formulates, using the artificial intelligence algorithm, and schedules the action item based on the event information and the activity information once the event is planned and confirmed.

The system then determines whether the vendor is involved in the action item. The system determines whether the integration is executed between the application programming interface of the server and the vendor. The system notifies the host on whether there is the integration between the server and the vendor. The system then automatically executes the action item at a predefined time prior to the event when the integration exists between the server and the vendor. The action item comprises at least one of a purchase of an item, rendering a gift card, participating in a game, ordering a food item, availing the service, communicating instructions, and processing a payment. The system also enables to the action item to be manually executed at a predefined time prior to the event when the integration does not exist between the server and the vendor.

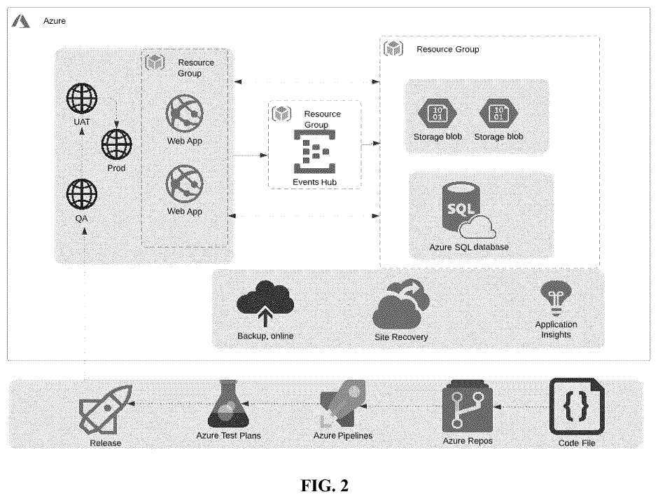

FIG. 2 illustrates an application hosting diagram, according to one or more embodiments. The source code in a code file is stored in a repository. The information is then retrieved via pipelines for testing. Once testing is done, the application is released for quality assurance testing, user acceptance testing and production testing. The application comprises one or more web applications within the resource group. The web applications communicate through an events hub for creating, organizing, and executing an event. The information/logs may be stored in Blob, and/or a database.

Application is designed to use SSL certificate in order to keep user data secure, verify ownership of the website, prevent attackers from creating a fake version of the site, and gain user trust. The application sets all the security controls in place for the users while playing online games.

Application leverages JSON Web Token® (JWT), an open standard RFC 7519, that defines a compact and self-contained method for securely transmitting information between parties encoded as a JSON object. The Bearer Token is stateless and can be handled through AUTH0 or any third party.

Token payload consists of claims consists of the user identity, roles, and permissions as well as resources that the user can access which helps in authentication and authorization of every API request that a client makes. Configured for a bot protection rule in a Web Application Firewall (WAF) for Application Gateway.

The system comprises an architecture to have API gateway and middleware to make sure each incoming API request has a valid token that is generated with a trusted secret key. Also, incoming requests are authenticated to make sure an unauthorized, uninvited user is not joining nor modifying hosted event, details, or payment.

FIG. 2 is more about how the application is hosted. In a sense, the application is hosted in an Azure environment and comprises different environments at production. And each environment has a micro account which provides a microservice background. The application comprises probably six to seven different micro services, which are APIs, which are all deployed as a web app. The web application communicates to the block storage or SQL, Azure® SQL® based on the request that comes from the user interface, UI. The application further has the Event Hub concept for real time events, especially for games, which need interaction or data flowing in real time without the browser even getting refreshed.

There are six or seven web apps in our application. Each Azure Web App will contain these micro services. The application not only has this application of integration, but also in-house APIs may have this application of integration, where restaurants can register within an application itself. Gaming APIs can also be integrated within our application. The system is capable of integrating with other online games. The application has currently five games built-in where people can play. Once the application is launched, the application is integrated with existing applications. Web APIs, like restaurant partners and online games. can be from third party partners. Payment API, games API, notification API are all deployed as a web app. Using the Azure® platform, services are grouped. Resource Group is a kind of network. The Web applications deploy Blob storage and SQL in one particular resource group called network. This particular resource group is used to accept requests only coming from this particular resource group in order to keep it secure enough so nobody can break in, even those with an Azure subscription. Nobody from outside of the resource group can make the request, or make the connectivity to the SQL box, because the way it is kind of configured is, this is a group should respond only the request coming from this particular group. It is more of sorting and isolating all these components within the Azure for security. Storage is something like where the application can save all documents, images, anything that is used. Storage is used to store all our restaurant image and then the terms and conditions.

The system comprises a third-party app, which can partner application where third party can register with, and can put their menu in. The system tracks and sends the orders automatically prior to predefined time (like three days before the event). The system sends these orders to the restaurants API at the predefined time prior to the event, so that restaurant do not miss an order so that they can send exactly all the order during the event without losing.

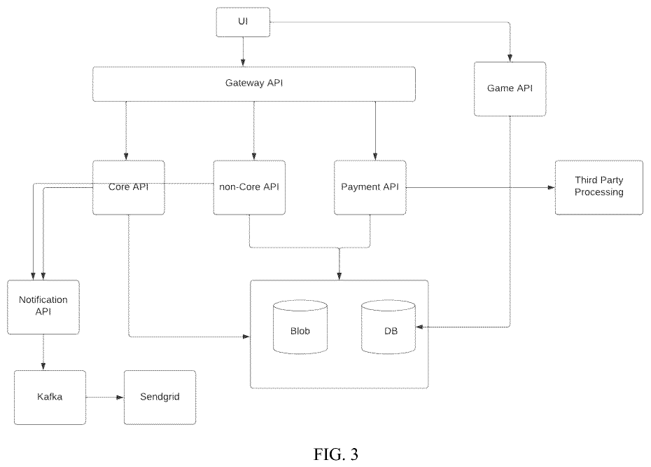

FIG. 3 is showing a system components integration, according to one or more embodiments. The integration diagram comprises a user interface (UI). The user interface enables the user to interact with the system to interact, create an event, plan an event, order, and mange an event. The UI communicates with gateway API where the authentication is performed. The user may provide input via the UI. The gateway UPI communicates with a core API, a non-core API, and a payment API. The core API may be an API within the system. The non-core API may be a vendor API.

The payment API is responsible for tracking bills, generate invoices, and making the payments. The payment API is responsible for processing third party processing payments. The core API and the non-core API communicates with a notification API. The notification API is configured to send notifications to the user (e.g., guest and/or host). In an embodiment, the notification API is configured to send notifications via tools (e.g., Kafka tool and SendGrid tool). These tools are used to minimize loss of data. The information from the core API, the non-core API, the games API, and the payment API are stored in a database like Blob.

For example, the user may provide input regarding an event creation via the UI. The gateway API authenticates the user. The user input is then segregated and then communicated to the core API, the non-core API, and the payment API. The core API of the server, upon receiving the event related information may create the event, organize the event, send an invite to the guest, etc. The core API of the server receives an input from a host device. The server automatically analyses, using an artificial intelligence algorithm, the input received from the host device and extracts at least one of details of a vendor, and details of a service to be availed from the vendor for an event.

The server then establishes a communication to the vendor through an integration established between an application programming interface of the server and the vendor. The server then automatically sends an enquiry to the vendor regarding purchase of at least one of the services and an item. The server then tracks an action item executed by a host for the event and estimates a first amount for the action item executed by the host, respectively. The server then generates a first consolidated invoice for the host based on the first amount in a first home currency of the host. The input comprises at least one of event information, host information, guest information, activity information, budget information, an event agenda, vendor information, return gift information, and reward information. The non-core API communicates with restaurants and other platforms regarding services to be availed for the event. The payment API communicates a first consolidated invoice for the host and or the guest.

In an embodiment, the system comprises an event manager with full automation. The system comprises the event manager for that specific event. The event manager will be validating things. The event manager may be a robot. The robot is configured to perform automations in the event managers responsibility. In an embodiment, the event manager may be a physical manager (e.g., admin) who will get to know event details, like attendee, orders, etc. The event manager's responsibility is making sure everything is in place for the event after the event and before the event or while the event is occurring. The event manager is a customer service. Every event will be assigned an event manager, but the customer host or guests can reach the customer service. The system assigns the event manager, and the user can communicate with the event manager, customer service, regarding any issues.

When the guest is doing RSVP, the system automatically takes the guest profile, if the system already has it. The system can automatically pull the event attending venue and the profile and pops it to the screen for the guest confirmation. The guest may provide a new address if the profile address is not the same as the event attending venue.

In an embodiment, the system, using Global System for Mobile Communications, GSM, tracks and identifies the guest location required for confirmation. Based on the address the guest enters, the system identifies the locale and the country where the guest is going. The system will showcase the gift cards according to the event attending venue or the address confirmed by the guest. The system shows only the US gift cards when the event attending venue is in the USA. Soon, after the guest orders, the US gift card will just show up in the guest profile itself. The guest can just log into the profile and email the gift card to the email in their profile.

For example, if the guest is a USA based user and coming to the platform for the first time, the guest has to enter the address in the form. But if the guest is already a user who has logged into the platform more than one time, then the system has your profile address and retrieves that address automatically. Based on the profile address, the system automatically pulls the profile address and enables the guest to confirm and or update the address based on his/her preference.

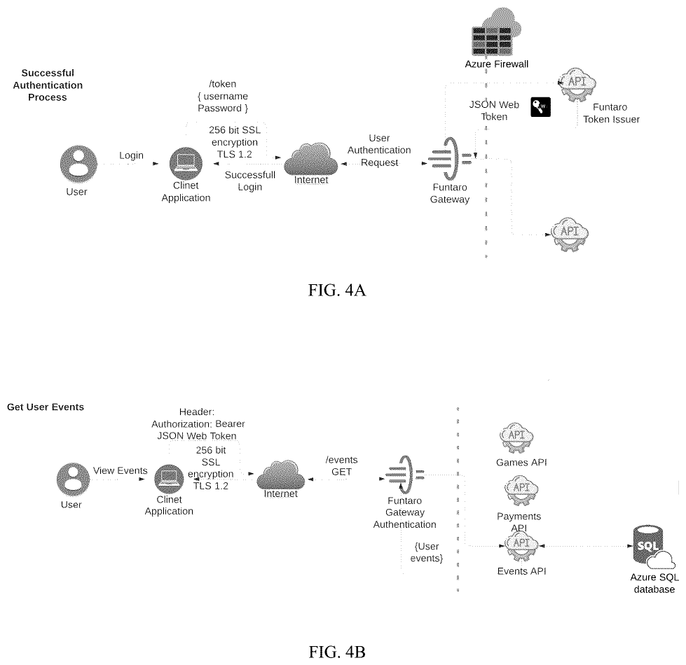

FIG. 4A is depicting a technical process flow for authentication of a user using the system, according to one or more embodiments. The experience API rests in the resource group and is not exposed to the internet for security reasons. The system is provided with a credentialed portal comprising the gateway API. Using a self-registration portal, a user can create his own account credentials, which he can then use to log in to the system via the client application interface. The user can open the client application, and log in to the portal using the credentials that he created through self-registration to access the system comprising a plurality of application programming interfaces via the client application. When a user tries to login into the system using a client application a token comprising a username and password are transmitted to the system's gateway API via the internet. In an embodiment, the token is encrypted using a Secure Sockets Layer (SSL) and Transport Layer Security (TLS) security protocol. In an example, the security protocol can be 256-bit SSL encryption TLS 1.2. In another embodiment, an azure firewall is used to enable real-time alerts and deny traffic from/to known malicious IP addresses and domains. In another example, the user can be a host of the event. In yet another example, the user is a service provider for the event.

FIG. 4B is depicting a technical process flow of viewing all planned events, according to one or more embodiments. In an example, the host user is made to authenticate his identity in order to access the system comprising a plurality of application programming interfaces via the client application. A credentialed host portal requires the host to have a username and password to gain access. Using a self-registration portal, the host can create their own account credentials, which they can then use to log in to the host portal. When the host opens the client application, they log in to the portal using the credentials that they created through self-registration. After successful authentication, the host is logged in to the system platform via the client application interface. The host can plan an event or access the status of a planned event after successful authentication and logging in to the application. Based on event details and input provided by the host, the system can execute one or more commands using a plurality of experience APIs of the system. A confirmation email, chat platform-based message, and/or SMS of an execution of a command is sent to the guest and host via the notification application programming interface of the system after successful completion of the execution of the command.

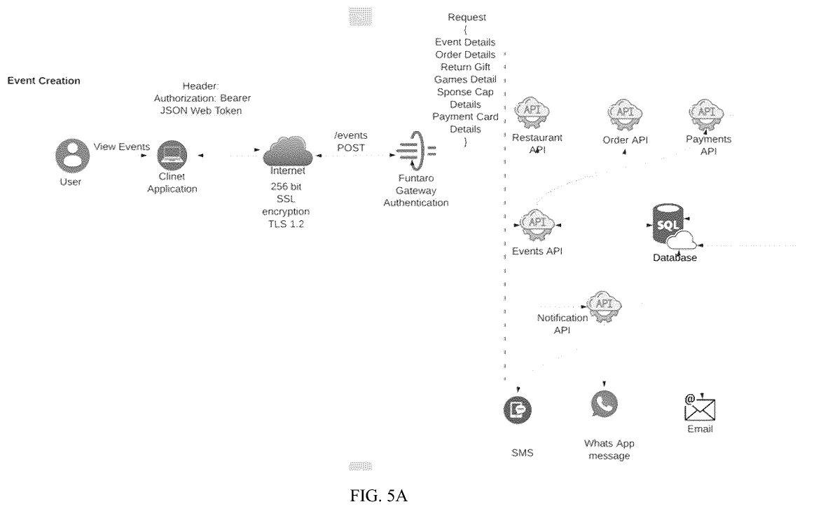

FIG. 5A is depicting a technical process flow of an event creation via a client application interface by the system, according to one or more embodiments. In an example, the user can view a digital bucket of planned events, a digital bucket of hosted events and a digital bucket of events to attend after successful login and host authentication by the system via the client application interface. In another example, the user can plan one or more events, after successful login and host authentication by the system via the client application interface. After receiving a request for event planning comprising one or more of an event detail, an order details, return gift detail, games detail, a sponsored cap detail, and a payment card detail, via a cloud firewall, the relevant commands are communicated to relevant experience APIs selected from one or more of a restaurant API, an order API, and a payment API via SQL Database. A confirmation email, chat platform-based message, and/or SMS of execution of command is sent to the host via the notification application programming interface of the system after successful completion of creation of the event.

FIG. 5B is depicting a technical process flow for voice command-based event planning and execution by the system, according to one or more embodiments. In an example, the system can receive a command to display a list of events for a time duration based on a voice command provided by the user via a virtual voice assistant platform. In another example, the system can plan an event based on a command provided by the user via the virtual voice assistant platform. In another example, the system can execute a food order received via the virtual voice assistant platform. In an example, the voice assistant platform can be one of Microsoft bot services, Alexa voice services or a Google Cloud Platform (GCP) Dialog Flow. After authentication of the host by the system authentication gateway (Funtaro® Gateway authentication), the commands are executed via the relevant application programming interface of the system and the cloud SQL command database. The relevant application programming interfaces are selected from one or more of an event application programming interface, an order application programming interface, a restaurant application programming interface, or a payment application programming interface. A confirmation email, chat platform-based message, and/or SMS of execution of command is sent to the host via the notification application programming interface of the system after successful completion of the creation of the event.

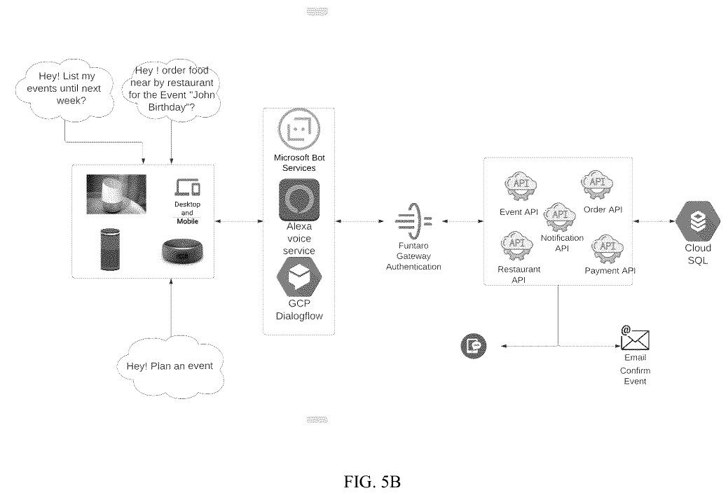

FIG. 6 is showing a graphical user interface (GUI) for the user of the event planning system according to an embodiment. Once the user enters the website or the application program (an App), he/she would visualize the screen as shown in FIG. 6, according to an embodiment. The screen comprises a navigation pane is shown at 601, an events overview 602, a quick actions bar 603 and more menu items which comprises information about the contacts made into groups 604. In the navigation bar the user can jump to the item in which he is interested to access from the application, for example to access transaction details as shown at 605 or any other item that is listed in the navigation pane. Similarly, in the Events overview, the user can check with highlights on how many events are already hosted or in the process of hosting, how many events are intended by him to attend, how many are still in the planning stage along with the completion state. This events overview bar 602 can guide the user quickly about the events of past, present and future, of which he/she is the host and/or the guest. The quick actions list 603 gives the user options for planning an event comprising any of food and drinks, games, gifts, or none or all of them. Further, the user can also plan for an instant event 606 where the event can be meeting the guests instantly.

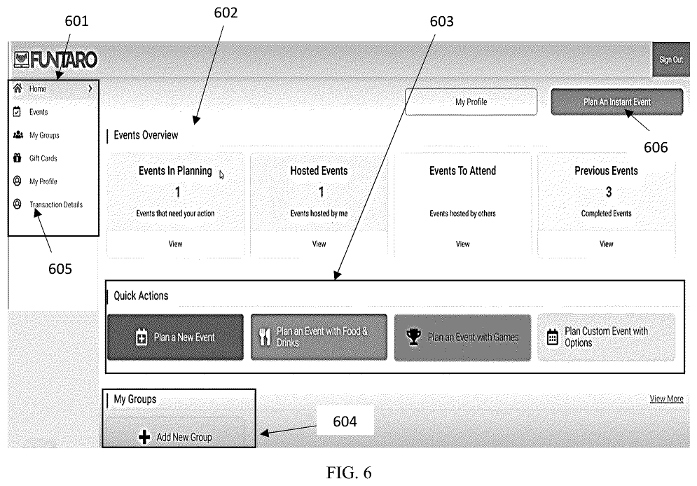

FIG. 7 is showing a progress in workflow and context-based display and collection of event related information for event details during the planning of an event tab using the system according to an embodiment. The event planning workflow steps are shown along with the progress at 701, which is in the event details tab. The steps comprise of Event details, attendees, food and drinks, games, return gifts, review, and confirm. When the planning of event is started, the overall details or high-level details of the event are collected at step 1 which is event details. At each step, a context-based display and collection of event related information is performed as shown in 702. For example, in the planning of an event at step 1 of 701, the details needed are shown in 702 as event name, date and time, event time zone, and whether the event should comprise food and drinks, games, and return gifts. As each of them is selected as yes or no, the workflow steps would dynamically change for keeping a certain item active or in-active at 701 to collect further information from the host or planner of the event.

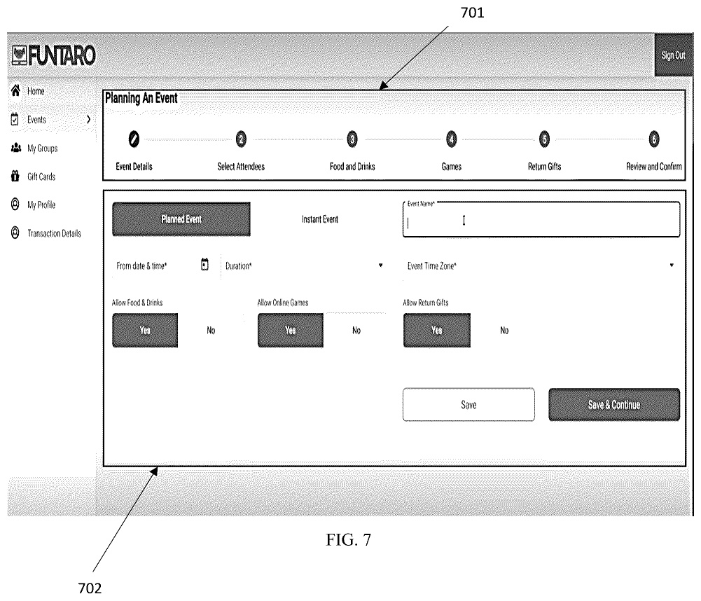

FIG. 8 is showing the progress in workflow and context-based display and collection of event related information including the select attendees tab. The event planning workflow steps are shown along with the progress in 801, which is at the select attendees tab. The context-based display and collection of event related information is as shown in 802. Selection of attendees can be made in multiple ways. In an embodiment, the guests' details can be provided in the interface, where guest details comprise of name, email address, physical address, and phone number. In an embodiment, the guest list can be provided via an import file where multiple guests can be imported. In an embodiment, the host contact list can be connected to the interface where the guests are populated by extracting the information automatically. In an embodiment, a guest group can be formed within the application program and such group can be used to select the guests. Once the guest list is shown, each individual guest can be selected, deselected, or edited as needed. In an embodiment, groups can be created using past events. In an embodiment, a group can be created on the fly. A group is a collection of individuals based on a user's categorization, for example, friends, relatives, colleagues, etc.

For an example, a user is a host organizing an event. The user may want to pull out contacts from different platforms. In the existing system, the user may have to do it manually, or the user may have an Excel sheet to transport. Whereas the system described herein, has this ability to transport contacts from one platform to another (e.g., like how connect plus does so, it pulls out the contacts). The system further provides the ability to have your own codes which can split the age group, etc. The system is communicatively coupled to a RSVP module which enables one to estimate this many kids and this many adults will be joining and accordingly providing purchase orders using AI. The system using AI recommends food order for adults and a different or customized gift for kids. So, all this is not being done manually, it is being done by your system. In an embodiment, the system enables adults to supervise an account of a kid.

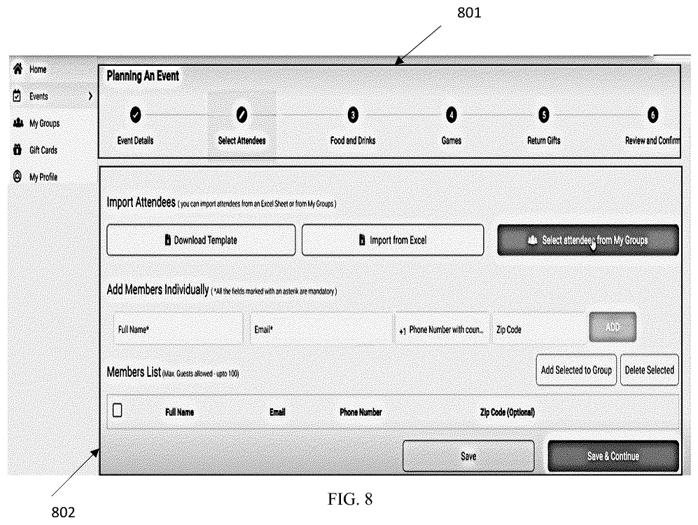

FIG. 9 is showing a progress in workflow and a context-based display and a collection of event related information for the food and drinks tab during the planning of an event using the system according to an embodiment. The event planning workflow steps are shown along with the progress in 901, which is at the food and drinks tab. The context-based display and collection of event related information for food and drinks is as shown in 902. The host can sponsor food and drinks to guests by means of allocating a certain amount of money for the same. Further, he can order food for himself. When ordering food for himself, the system asks for an address along with zip code. In an embodiment, the address is populated from his personal information or contact card stored in the email or in any other platform. A host can also provide an address of the location from which he will be celebrating the event. For example, a location where he may be spending his holiday or a vacation. The system will populate the food and drink serving business, registered with the system, and which are available during the time of the event, at the location which was provided by the user. A menu for each of the restaurants or food and drinks businesses is shown on the list from which the user can select and confirm the order. In an embodiment, the order value can be more than the sponsored value and the difference is billed to the host in cases where the host is ordering the food for himself. In an embodiment, the host can order food for whole of the host's family and get that invoiced in the bill. In an embodiment, if the host wishes not to order food for himself, the host can choose gift cards or any other item that is listed by the system. The option for using the money in terms of gift cards is provided in an embodiment.

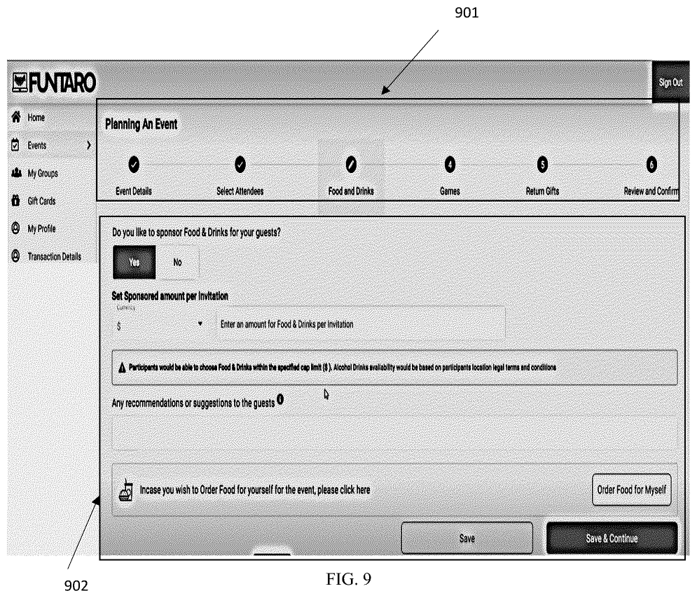

FIG. 10 is showing a progress in workflow and context-based display and collection of event related information for the games tab during the planning of an event using the system according to an embodiment. The event planning workflow steps are shown along with the progress in 1001, which is at the games tab. The context-based display and collection of event related information for games is as shown at 1002. In an embodiment, the user can choose the games that are floated by the system. In an embodiment, the user can configure new games such as a pop-up quiz or other question and answer-based games. In an embodiment the games can be based on a theme or a subject. In an embodiment, the games can be accompanied with gift items. In an embodiment, the games can be lucky dip or lucky draw. The number of gifts and the amount for the gift is dependent on the host. In an embodiment, the games can be chess, movie quiz, nature quiz, family quiz, board games, and the like. In an embodiment, the games can be any video games that are commercially available. In an embodiment, any third-party game that is integrated with the system can be accessed and played. In an embodiment, the access for a certain game or access for a certain level/s in the game, or access to a certain number of total users is controlled by the system.

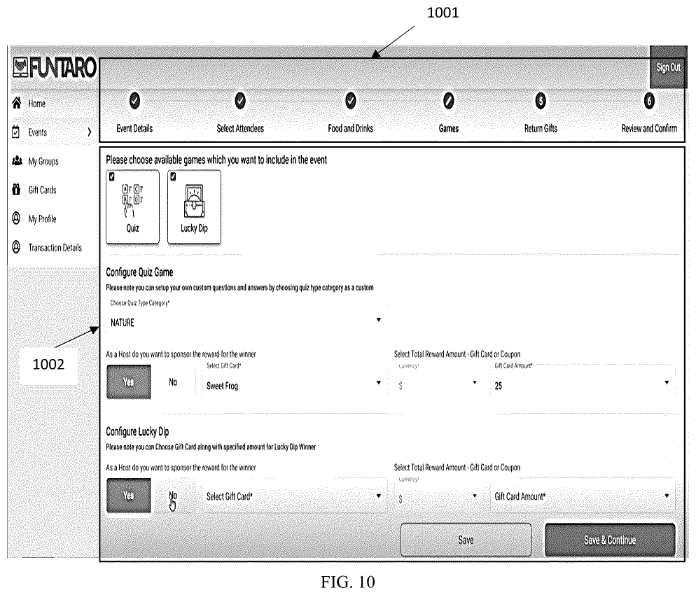

FIG. 11 is showing a progress in workflow and context-based display and collection of event related information for the return gifts tab during the planning of an event using the system according to an embodiment. The event planning workflow steps are shown along with the progress at 1101, which is at planning return gifts. The context-based display and collection of event related information for planning return gifts is as shown at 1102. In an embodiment, options shown at 1102 are from the vendors that are registered with the system. In an embodiment, the options available will be from e-commerce websites. The host can sponsor a certain amount per invitation. For example, for a birthday party invitation the host can sponsor a certain amount or specific type of gift item, a soft toy, or a coffee mug, from an e-commerce website to all the invitees. In an embodiment, any item that is to be sent to a guest address, will be delivered to the guest address mentioned in the system. In case of gift cards, the gift card information is sent to the guest email once the guest accepts the return gift.

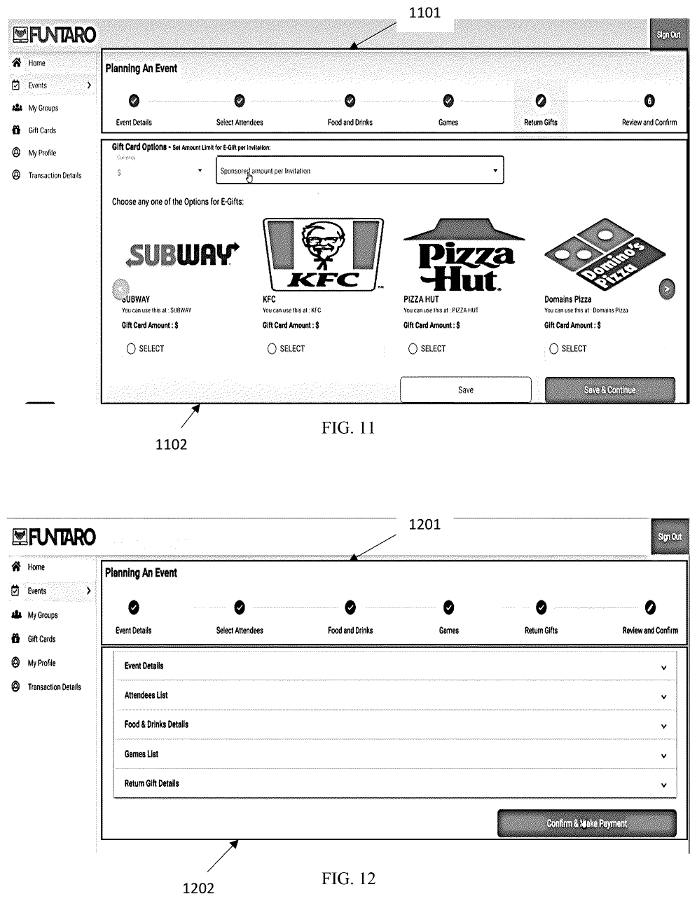

FIG. 12 is showing a progress in workflow and context-based display and collection of event related information for the review and confirm tab during the planning of an event using the system according to an embodiment. The event planning workflow steps are shown along with the progress in 1101, which is at the review and confirm tab. The context-based display and collection of event related information for review and confirmation is as shown at 1102. The previous steps of event details, attendees list, food and drinks details, games list involved, return gift details can be reviewed, changed as necessary, and can be confirmed by the user. Once the details are confirmed the system leads to a payment details information.

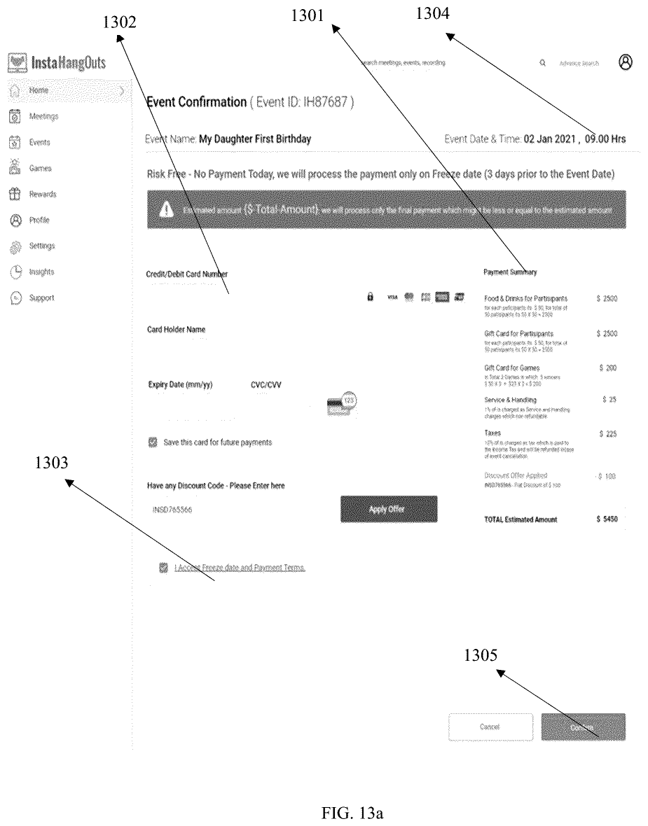

FIGS. 13a and 13b shows payment related information, according to one or embodiments. Once the event details are provided the system generates the total amount that the user will be spending on the event, in an itemized manner, as shown at 1301. It further the enables the user to add a payment card information via a user interface at 1302. Payment card information enables the user to provide information such as card number, card holder name, expiry date, and Card Verification code/Card Verification Value (CVC/CVV). The system also enables the user to add any discount code via the user interface at 1303. In an embodiment, terms and conditions related to payment are listed at 1303. The freeze date is shown at 1304. According to an embodiment, until freeze date, the user can make changes to the event and the payment is not deducted from the user. The freeze date, according to an embodiment is at least 3 days before the planned event date. The system enables the user to confirm the details via the user interface at 1305. FIG. 13b shows a pop-up screen that enables the user to cross check freeze date and payment terms. FIG. 13b enables the user to verify the freeze date and payment terms and proceed with the confirmation.

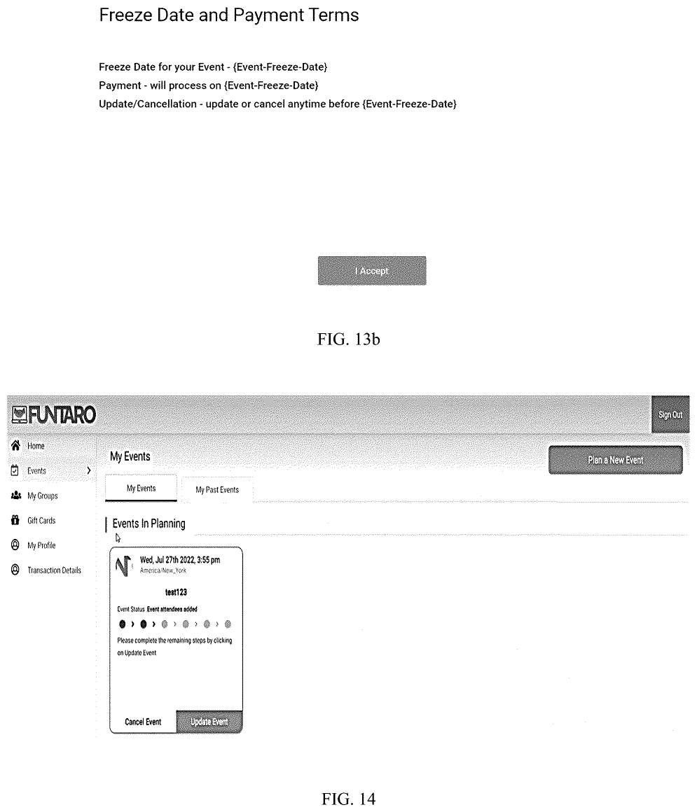

FIG. 14 shows current events that are in the planning stage according to an embodiment. Once the event planning is paused or completed, an overview of the event plan is displayed in current events where the progress of planning is displayed for an overview of the user as shown at 1401. In an embodiment, once the invite is sent to the invitees, the GUI may show the number of guests invited, how many accepted and how many rejected.

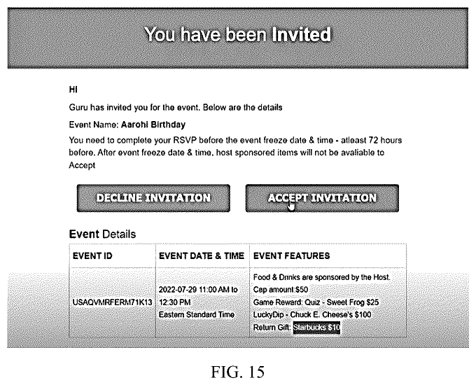

FIG. 15 shows an invitation summary that is sent to the guest or an invitee according to an embodiment. An email invite comprising the summary of the event as shown in FIG. 15 is sent to the invitee. The invitee/guest can accept the invitation or decline the invitation. In either case, the user has to login to the system for a secured communication. In an embodiment, the user can accept the return gift even if he declines the invite.

The system analyses, using the artificial intelligence algorithm, the input received from the host device and extracts at least one of details of a guest, and the details of the service to be provided to the guest. The system automatically sends an invite for the event to the guest based on at least one of the details of the guest, and the details of the service to be provided to the guest.

Once the guest logs into the system, the system provides him the options of accepting the invitation and providing his address from where he will be attending the event. This address can be changed within the freeze date according to an embodiment. Once the guest or invitee provides the address from which he will be attending the event, the restaurants, and eateries around that location, which are open during that time, are shown to the invitee. The invitee can select the food he wishes to order, and the food will be delivered to the guest during the party time. The party time is based on the host location. If the host and guest are at two different geographical locations, the food delivery will be done based on the host's time zone at the guest's location. For example, if the host is in the US and the party is being organized at 12:00 PM EST on a specific day then the corresponding IST for that day will be used for the guest for all the services that are provided via the system for the event. Thus, the system considers the locale of each of the invitee for the event time details as planned by the host. The guest further can accept the return gift. In an embodiment, if the guest does not wish to order food and drinks, the guest can order a gift card for the sponsored amount. In another embodiment, the guest can order an amount less than the sponsor amount and the difference is taken care of while invoicing the host. In another embodiment, the guest can order or utilize a higher amount than the sponsored amount, wherein the difference amount is paid by the guest. The guest can also accept the return gift, and to make the transaction secure, the gift card details are shared via email.

In an embodiment, the guest can also sponsor the gift or food and drinks to the host or to a certain number of invitees (for example, a guest might be demonstrating a product to the host and the invitees). In another embodiment, the guest can sponsor a certain amount to the host towards the event organization.

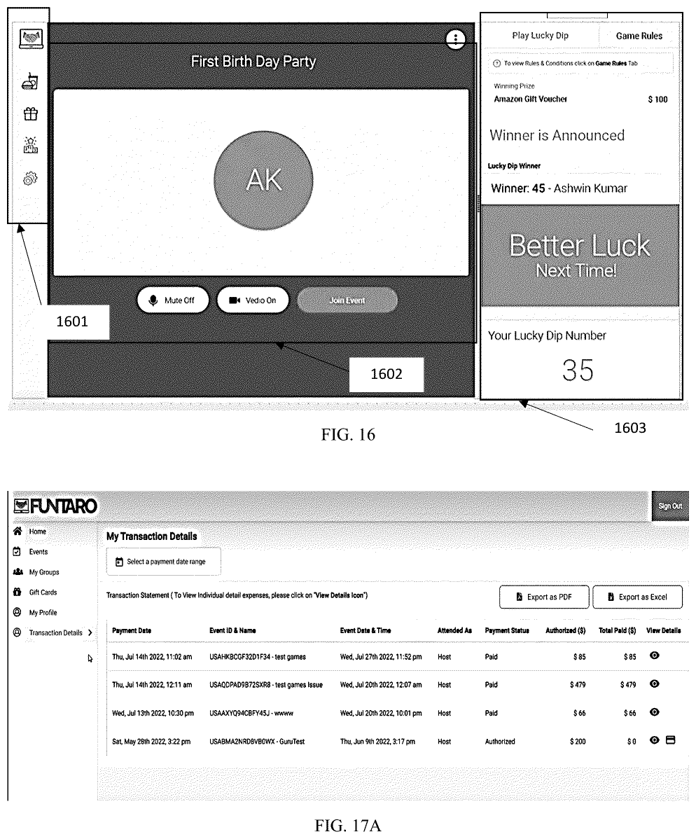

FIG. 16 shows the event interface, where the host and guests interact virtually according to an embodiment. The interface has a navigation panel as shown in 1601 where the user can navigate through the event items. As shown in 1602, a display of the event is shown and the video interaction space is provided where the guests can talk, interact, and enjoy. Updates or any information that needs to be broadcast is shown at 1603. In an embodiment, the system will enable users to capture the memories. In an embodiment, artificial intelligence algorithms are used for various backgrounds and foregrounds as needed by the user. In an embodiment, the system randomly captures the images and prepares a collage of the event. In another embodiment, the social media is connected and the photos of users from the social media platforms are used for preparing the collage. In an embodiment, the photos are directly stored to a database. In another embodiment, the system seeks permission of the user to include them in the picture. In another embodiment, the people are not captured if the local laws do not permit this. In another embodiment, all the users who do not permit their photo to be displayed or stored, a replacement cartoon in their position will be made.

In another embodiment, if there is a conference and there are speakers and there are groups of students to whom the speakers want to give a speech, the system extracts the speaker's information and the guest information (e.g., kids' information) from the input received. Speakers and their time routines are extracted and provided in their client platform in the client API of the system. That system performs an automated time planning based on the input, using AI, and pops up a notification to an intended attendee in a predefined time period (e.g., 15 seconds) regarding an upcoming activity in the event (e.g., that the speech is going to start). The system notifies the attendee/host to prepare the slides and there is no time delay. The notification enables the user to remind the students that they are indulged in whatever presentation is going on. The client specific user interface is visible to every single attendee which enables to notify and remind each and every activity of its upcoming in the event.

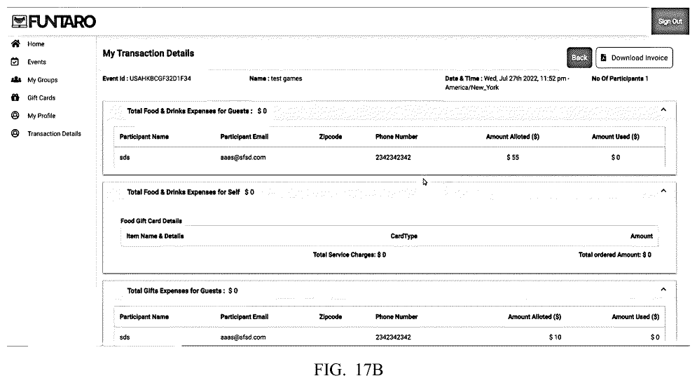

FIG. 17A shows an invoice summary generated for the host according to an embodiment. FIG. 17B shows the itemized details of the invoice according to an embodiment. The host can have guests from all over the world. It could be India, it could be the US, it could be Canada, it could be Mexico, and the like. The finances are going to be based on the number of participants and the sponsored amount. For example, the host invites 10 USA guests and 10 India guests and can sponsor a separate amount for each guest based on their location. For example, the host can sponsor $50 for an invitation to a guest in the US and 5000 rupees for guests in India. The invoice for the host will show the details on how many guests accepted and how much the sponsor amount is for each guest. However, for the host, the invoice will always be in US dollars or the currency of the land where the host resides or chooses. When the guests use partial amounts of the sponsored amount, then the host is only charged with the amount that the guests have utilized and not the sponsored amount in total.

For example, a host is hosting an event and is planning the event with sponsoring games, return gifts, etc. The money is collected from the host on the freeze date, at least 3 days before the event date. In an embodiment, the freeze date is based on the event complexity and the number of orders or items involved in the event. In one embodiment, the system enables the user to set the freeze time. The host and guest cannot make any changes after the freeze date. On the freeze date, the money collected from all the guests and hosts, note that the guests can order more than the host sponsored amount and the guests can sponsor a part of the event for the host. So, there may be a payment on the guest side as well. The payment is collected from the host and/or the guest by the system and the system will be paying out the bills for all the vendors. In an embodiment, the prices are honoured as booked on the booking date. In another embodiment, any change in the price is further billed to the client or the user. All the changes in the pricing are reflected in the invoicing and all the details are provided for each item as shown in FIG. 17B.

For instance, the system tracks the action item executed by a guest for the event separately. The system estimates an amount for the action item executed by the guest. The system then generates a consolidated invoice for the guest based on the amount estimated; and finally, the system renders the consolidated invoice for the guest in a home currency of the guest.

In yet another embodiment, the system estimates the amount for the action item executed by the guest (Game, estimates $20.00). The system tracks the action item executed by the guest; determines a second amount spent by the guest ($10.00) based on tracking the action item executed by the guest; compares the second amount ($10.00) and a cap amount in the budget information ($40.00); and calculates a difference in amount between the second amount and the cap amount as the amount to be billed to the host ($30.00 billed to the host).

The concept of the system is that the guest can attend more than one event in more than one attending venue in a single day and have meals ordered from the restaurants in the respective event attending venue. For example, the guest may attend a conference in the morning, somewhere in California. In the evening, the guest may attend a niece's birthday party happening in his home. And in the night, the guest may actually drive in his car to XYZ location. The guest is enabled to provide the attending venue for all three events while RSVP'ing the event. The system, upon extracting the event attending venues, extracts a locale at which the guest will be attending the meeting. The system, using AI, checks for any restaurant open at that point and makes purchase orders to the restaurants using AI. The system also receives a confirmation of order from the restaurant. Once the order is confirmed, it is the restaurant's responsibility to deliver the food to the guest. The system may issue a gift card to the guest if no restaurants are available at that locale at that point of time. The system can then render the gift card to the guests. The guests may avail the gift card later and purchase any item.

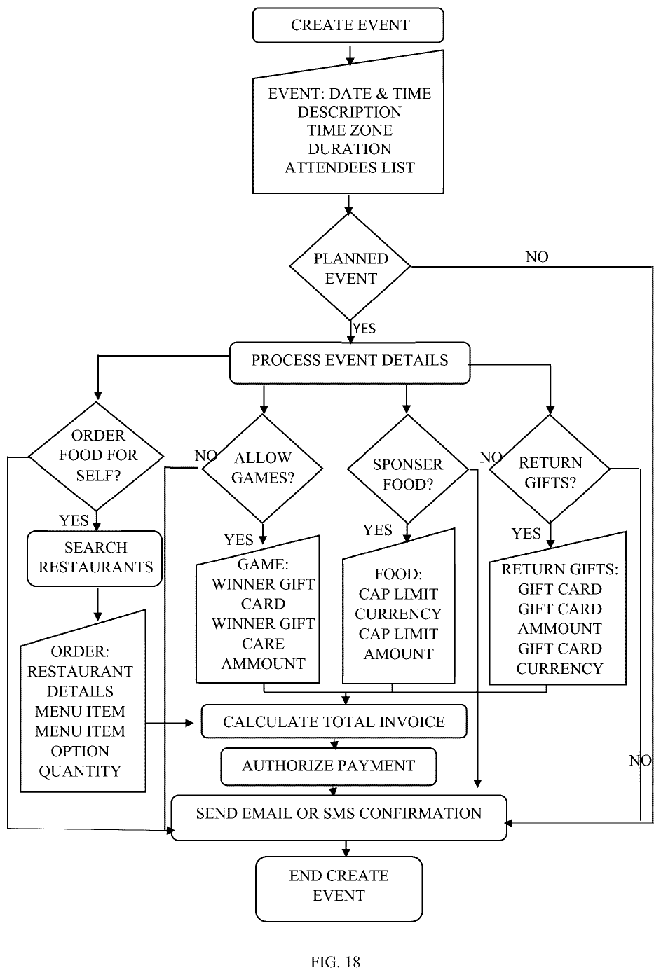

FIG. 18 is showing a process flow of event creation using the system, according to one or more embodiments. In an example, a user can plan an event by clicking on a “Plan an instant event” icon. In another example, the user is provided with quick action options that may include a) Plan a new event b) Plan an event with food and drinks c) Plan an event with games and d) Plan custom event with options. The event can be created by inputting an event name, an event date and time, an event time zone, an event duration, and an attendees list. In an example, the attendees may be selected from an already existing group created for previous events. In another example, the list of attendees may be uploaded to the system using an excel sheet. In another example, invitees may be added individually by the host by providing at least one of an email ID, a social media-based ID, and a phone number of the invitee. In cases where the event planning is successful, the user is allowed access to process event details using relevant event detail icons (for example: food, games, and sponsor food, and return gift). In case the event planning is not successful, the system sends an SMS or email notification to the user.

In an embodiment, cultural aspects are taken care of by the system. In an example, the system based on the input data and historical data predicts a cultural behaviour and accordingly recommends various aspects of the event planning. In an example, if the predicted cultural aspect is of Asian type, the host is recommended to sponsor the food and return gifts and the guest is recommended to send a gift to the host based on the event name and locale. In another example, if the predicted cultural aspect is of western type, the host and guests are recommended to order items for themselves.

In another embodiment, the user can order one or more of food, return gifts and rewards on the fly while attending the event and the system sends a tentative time duration in which item/s will be delivered to the user. In another embodiment, a host for an event is provided with options for sponsoring one or more of food, returning gifts and rewards for the event or ordering food in advance for self, while providing event details during planning of the event. If the host selects the option of sponsoring food, he is asked by the system how much amount is to be sponsored per invitation. In an example, the host is asked about the currency of the sponsored amount as well. In another embodiment, the currency may be recommended by the system based on the time zone available for the guest from the historical data.

In an example, the host may provide recommendations or suggestions (for example a restaurant type, a dish type, or a dress code) to the guest via the system. In an example, when the host orders food or drinks for himself during the event planning, he is provided with an option of available restaurants using a search string generated based on the address provided by the guest. After selection of a restaurant by the host, the options of details of the restaurant including menu items, menu item options and quantity of food is displayed by the system to the user. In an example, an address can be selected as a primary delivery address for future events by the host or the guest using the system. In another example, the host or the guest may override the primary address to an address from where they will be hosting/attending the planned event. The recommendations of the available restaurants are provided based on the address, the locale and the time zone provided for attending/hosting the planned event at the planned time. In another embodiment, the guest can order food up-ahead before the planned event.

In an example, the system also displays the availability of a pickup facility or delivery facility for the event date time. In an example, if there are no restaurants available for a user or the user does not want to order food or drinks using the sponsored amount for the event time in the provided locale, the user is provided with an option of one or more gift cards. In an example, if the user has an insufficient sponsored amount, the gift card, foods and or drinks can be bought by the user paying the extra additional amount. Gift cards may comprise a food gift card or a drink gift card. In an example, if the host selects games for the event a game selection option is provided to the host. The host can also sponsor a reward for the winner of the game. In an example, when the host chooses to sponsor for the reward to the winner, the host is asked how much amount is to be sponsored per game. In an example, the reward may be provided in the form of a gift card or a coupon. In an example, the host is provided with an option to sponsor a return gift per invitation. Based on an amount entered by the user, a recommendation of return gift is provided based on the event name, the predicted cultural aspect and a host behaviour identified by the system via an artificial intelligence and machine learning module of the system.

In another embodiment, the system calculates the total invoice after completion of providing the details of order by the user and displays the order summary. After confirmation of the order summary and a payment detail by the host, a payment process is initiated by the payment gateway of the system. The host may review and make changes to the event details until the freezing date of the event is picked up by the system. In an example, no payment is processed before the freezing date. In an example, an option for entering a discount code is provided by the system. A confirmation is sent to the host and an invitation to the invitee by the system, after the final confirmation of the payment by the host. The event is visible in an “event in plan” bucket with the event status and pending steps.

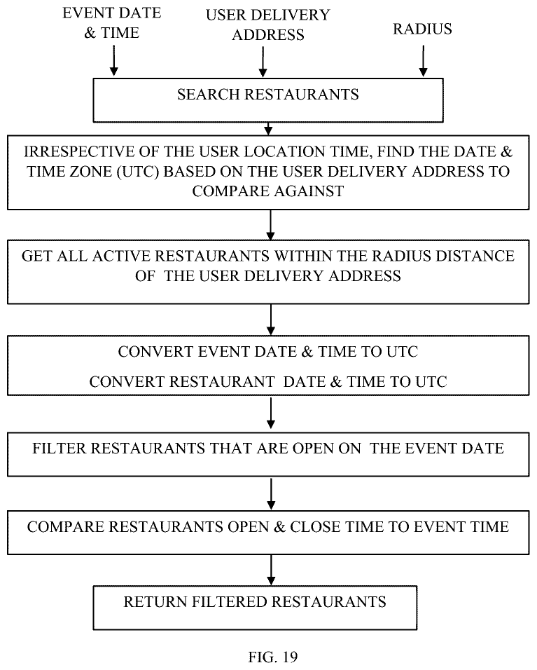

FIG. 19 is showing a process of searching for restaurants via the system, according to one or more embodiments. The system based on the event date and time and based on user delivery address searches for restaurants in a predefined radius using a navigation system. In an embodiment, the system, irrespective of the user location time, finds the date & time zone (UTC) based on the user delivery address to compare against. The system gets real-time data on all active restaurants within the radius distance of the user delivery address. In another embodiment, the system converts event date & time to UTC and converts restaurant date & time to UTC. The system filters restaurants that are open on the event date and compares restaurants' opening & close time to the event time. The system then returns the filtered restaurant list and displays the list to the user via the client application.

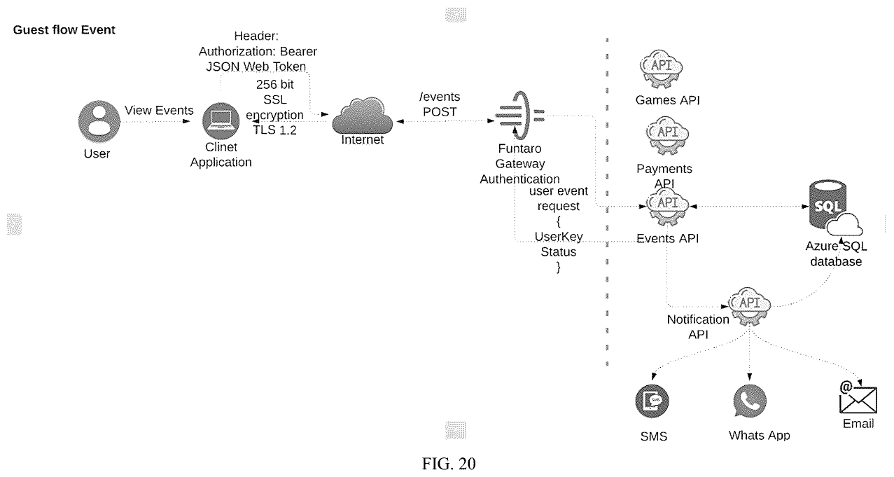

FIG. 20 is depicting a technical process flow for accepting an event by the guest via the system, according to one or more embodiments. In an embodiment, after clicking on the invitation for an event, the guest user is taken to a web-based client application interface of the system. In an example, the guest user is made to authenticate his identity in order to RSVP to the event. A Credentialed Guest Portal requires guests to have a username and password to gain access. Using a self-registration portal, guests can create their own account credentials, which they can then use to log in to the Guest portal. When guests connect to a network, they are redirected to a portal. They log in to that portal using the credentials that they created through self-registration. After successful authentication, the guest is logged in to the system platform via the client application interface. The guest can access and execute a command using a plurality of APIs of the system. A confirmation email, chat platform-based message, and/or SMS of execution of a command is sent to the guest and host via the notification application programming interface of the system after successful completion of execution of the command.

In an embodiment, the system comprises a set of adaptive intelligence facilities. The adaptive intelligence facilities include an artificial intelligence and machine learning module (hereafter AIML module) and a robotic process automation module (hereafter RPA).

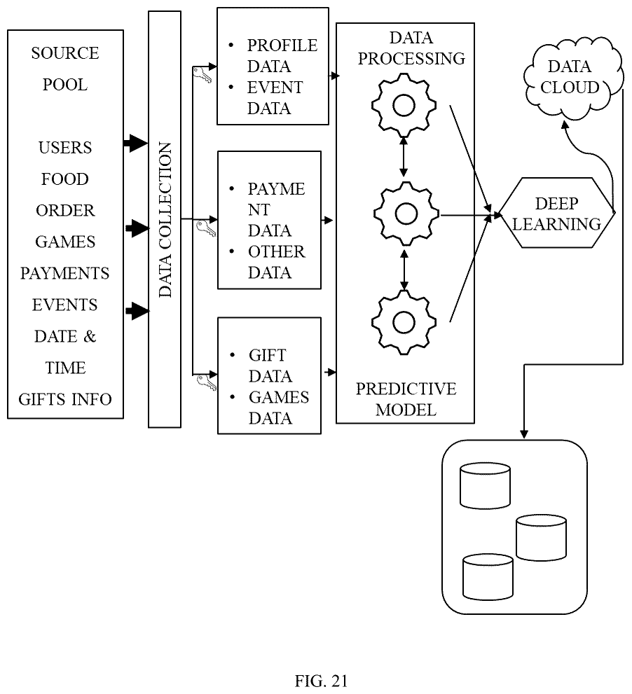

FIG. 21 shows a process flow of an artificial intelligence and machine learning module of the event planning system, according to one or more embodiments. The AIML module uses a plurality of algorithms to build a plurality of predictive models using a plurality of datasets. A dataset comprising real-time and historical data of user related data, food order, games, payments, event type, event date and time, and gift info are used in automatically generating models using statistical techniques including but not limited to machine learning, active learning, reinforcement learning, transfer learning, and deep learning. The said models are applied for a variety of applications in conversational artificial intelligence (AI) including but not limited to message response generation, AI assistant performance, and other language processing, primarily in the context of the generation and management of dynamic conversations.

The AIML also predicts a host behaviour and a guest behaviour based on historical order data and search history. In an example, the AIML module can recommend invitees, games, gifts, food, drinks, etc., based on the event type, search history, host behaviour, guest behaviour and an applicable offer by the vendor. Algorithms that may be employed by the AIML module in recommending invitees, gifts or games, etc., include K-neighbour classifier, support vector machines, Gaussian Process classifier, decision tree classifier, random forest classifier, multi-layer perceptron classifier, AdaBoost Classifier, Gaussian naïve bayes, Quadratic Discriminant Analysis, Linear Discriminant Analysis, stochastic gradient descent classifier, Bagging Classifier, extra trees classifier, gradient boosting classifier and voting classifier. In high-dimensional spaces, data can more easily be separated linearly and the simplicity of classifiers such as naive Bayes and linear support vector machines might lead to better generalization than is achieved by other classifiers. In spaces with fewer dimensions, nearest neighbours, random forest, and Gaussian process may be preferred. In some embodiments, all component features are extracted using map-reduce framework, the combination set of the component features is optimized, the top performing machine learning algorithms are optimized along with their parameters, and lastly the best ensemble of top-performing machine learning algorithms are optimized.

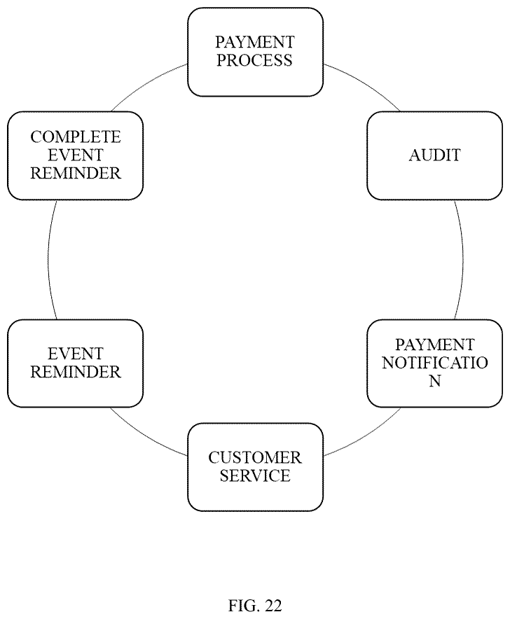

FIG. 22 is a block diagram showing a robotic process automation module for sets of virtual event applications for a category of task, using the system according to one or more embodiments. In an embodiment, software bots that mimic human activities are developed and deployed to control and communicate with digital systems performing one or more tasks. The task comprises at least one of a payment process, audit, payment notification, customer service, event reminder, and complete event reminder. Depending upon the application, there may also be rules, logic, and artificial intelligence added to the scripts (i.e., number of payments per cycle, limits on invoice amount, etc.).

In an embodiment, during audits, RPA bots can record data and generate reports. The reports can be shared automatically with those who need to see them for review and approval. In another embodiment, the RPA uses schedule triggers to automatically set and provide a reminder for an event or one or more tasks planned for the event using data extracted from the user to the system. In another embodiment, RPA automates customer services using rule-based processes to respond to queries raised by customers in real-time and to reduce turnaround time to seconds, freeing up human resources for more critical tasks. With the help of artificial intelligence, RPA can also resolve queries that need decision-making. By using NLP (Natural Language Processing), Chatbot Automation enables bots to understand the natural language of chatting with customers and responding like humans.

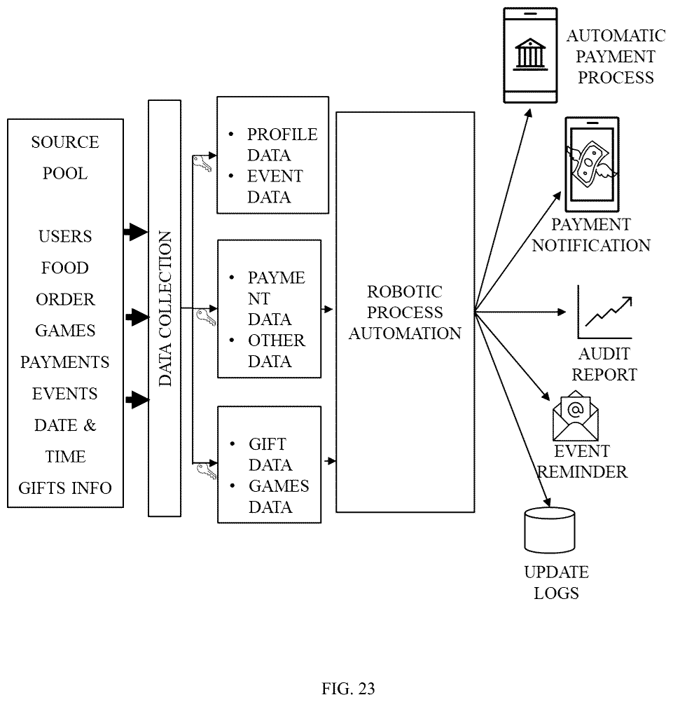

FIG. 23 is showing an automation process by the robotic process automation module of the system, according to one or more embodiments. In an embodiment, the robotic process automation layer uses information collected by a data collection layer from a source pool and a set of outcomes and activities involving the applications of the application layer to automate a set of actions for at least a subset of the applications with respect to virtual event execution. The source pool comprises user data, food order, games, payments, event date and time, and gift information. The BOT pulls in relevant data from specific locations to perform the functions without human intervention, such as automatic payment, payment notification, generating audit report, event reminder and updating logs.

The foregoing disclosure provides illustration and description but is not intended to be exhaustive or to limit the implementations to the precise form disclosed. Modifications and variations are possible in light of the above disclosure or may be acquired from practice of the implementations.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. The invention may also be practiced in distributed system environments where local and remote computer systems, which are linked (either by hardwired data links, wireless data links, or by a combination of hardwired and wireless data links) through a network, both (local and remote computer systems) perform tasks. In a distributed system environment, program modules or units may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Although the present embodiments have been described with reference to specific example embodiments, it will be evident that various modifications and changes may be made to these embodiments without departing from the broader spirit and scope of the various embodiments. For example, the various devices, units, and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a non-transitory machine-readable medium and/or a system. Accordingly, the specification and drawings are to be regarded in an illustrative rather than a restrictive sense.

### INCORPORATION BY REFERENCE

All references, including granted patents and patent application publications, referred herein are incorporated herein by reference in their entirety.
JP2022072455A titled “Virtual event system, information processing device, output control method and program;”
WO2021229286A1 titled “A system and method for providing virtual blessing using holographic telepresence is disclosed;”
US20220070411A1 titled “System for creating virtual environments for virtual events;”
US20180276776A1 titled “Process and system in which a person can attend an event like a funeral remotely;”
U.S. Ser. No. 10/909,639B2 titled “Acceleration of social interactions;”
U.S. Ser. No. 10/848,807B2 titled “Digital jukebox device with karaoke and/or photo booth features, and associated methods;”
U.S. Ser. No. 10/937,239B2 titled “System and method for creating an environment and for sharing an event;” US20210051033A1 titled “Systems and methods for virtual interactions;”
U.S. Ser. No. 10/967,255B2 titled “Virtual reality system for facilitating participation in events;”
U.S. Ser. No. 10/013,805B2 titled “Control of enhanced communication between remote participants using augmented and virtual reality;”
U.S. Pat. No. 9,817,912B2 titled “System And Method For Creating And Sharing A 3D Virtual Model Of An Event;”
U.S. Ser. No. 10/872,322B2 titled “System and method for collaborative shopping, business and entertainment;”
U.S. Ser. No. 10/805,365B2 titled “System and method for tracking events and providing feedback in a virtual conference;”
US20180373320A1 titled “Social applications for augmented reality technologies;”
U.S. Pat. No. 9,808,706B2 titled “Multi-dimensional game comprising interactive physical and virtual components;”
U.S. Pat. No. 9,160,692B2 titled “Interactive live political events;”
U.S. Ser. No. 10/713,494B2 titled “Data processing systems and methods for generating and interactive user interfaces and interactive game systems based on spatiotemporal analysis of video content;”
US20200225844A1 titled “Mass media presentations with synchronized audio reactions;”
US20090013263A1 titled “Method and apparatus for selecting events to be displayed at virtual venues and social networking;” and
US20220201017A1 titled “Securing endpoints in a heterogenous enterprise network.”

1-44. (canceled)

45. A method comprising:
communicating, by a server, an invite for an event to a guest device, wherein the invite comprises at least one of event information, host information, guest information, activity information, budget information, vendor information, and reward information;
receiving, by the server, at least one of a response and an event attending venue from the guest device in reply to the invite;
automatically determining, by the server using an artificial intelligence algorithm, a first locale of a guest based on the event attending venue;
automatically generating, by the server using the artificial intelligence algorithm, a purchase order for the guest based on the first locale, a second locale at which the event is planned, and an input received from a host device; and
automatically communicating, by the server, the purchase order to a vendor at a predefined time prior to the event based on the first locale of the guest, wherein the purchase order comprises at least one of an item, a service, a delivery date, a delivery time, a mode of payment, a cap amount for the purchase order, a delivery instruction, and a delivery address.

46. The method of claim 45, automatically determining, by the server using the artificial intelligence algorithm, the first locale of the guest based on the event attending venue comprises:
determining, by the server using the artificial intelligence algorithm, a time for the guest at which the event is to be executed; and
recommending, by the server using the artificial intelligence algorithm, at least one of the item, and the service, to generate the purchase order.

47. The method of claim 45, wherein receiving, by the server, at least one of the response and the event attending venue from the guest device comprises:
sending, by the server, an enquiry to a calendar module within the guest device;
extracting calendar information from the guest device in reply to the enquiry, wherein the calendar information comprises an accepted meeting invite, a cancelled meeting invite, a tentative accepted meeting invite, and an unanswered meeting invite; and
determining, by the server using the artificial intelligence algorithm, an availability of the guest based on the calendar information extracted from the guest device.

48. The method of claim 47, further comprising:
determining, by the server using the artificial intelligence algorithm, the event attending venue of the guest based on the calendar information extracted from the guest device.

49. The method of claim 48, wherein determining, by the server using the artificial intelligence algorithm, the availability of the guest based on the calendar information extracted from the guest device comprises:
receiving, by the server, at least one of the response and the event attending venue from the guest device comprises, upon determining the availability of the guest for the event and the event attending venue.

50. A method comprising:
receiving, by a server, an input from a host device, wherein the input comprises at least one of event information, host information, guest information, activity information, budget information, an event agenda, vendor information, return gift information, and reward information;
automatically analyzing, using an artificial intelligence algorithm, the input received from the host device and extracting at least one of details of a vendor, and details of a service to be availed from the vendor for an event;
establishing a communication to the vendor through an integration established between an application programming interface of the server and the vendor and automatically sending, by the server, an enquiry to the vendor regarding purchase of at least one of the service and an item;
tracking an action item executed by a host for the event and estimating a first amount for the action item executed by the host, respectively; and
generating a first consolidated invoice for the host based on the first amount in a first home currency of the host.

51. The method of claim 50, further comprising:
analyzing, by the server using the artificial intelligence algorithm, the input received from the host device and extracting at least one of details of a guest; and the details of the service to be provided to the guest.

52. The method of claim 51, further comprising:
automatically sending, by the server, an invite for the event to the guest based on at least one of the details of the guest; and the details of the service to be provided to the guest,
wherein the invite comprises at least one of the event information, the host information, the guest information, the activity information, the budget information, the event agenda, the vendor information, and the reward information.

53. The method of claim 50, further comprising:
formulating, by the server using the artificial intelligence algorithm, and scheduling the action item based on the event information and the activity information.

54. The method of claim 53, wherein formulating and scheduling the action item based on the event information and the activity information comprises:
determining whether the vendor is involved in the action item;
determining whether the integration is executed between the application programming interface of the server and the vendor; and
notifying the host device whether there is the integration between the server and the vendor.

55. The method of claim 54, further comprising:
automatically executing the action item at a predefined time prior to the event when the integration exists between the server and the vendor, wherein the action item comprises at least one of a purchase of the item, rendering a gift card, participating in a game, ordering a food item, availing the service, communicating instructions, and processing a payment.

56. The method of claim 54, further comprising:
executing the action item manually at a predefined time prior to the event when the integration does not exist between the server and the vendor, wherein the action item comprises at least one of a purchase of the item, rendering a gift card, participating in a game, ordering a food item, availing the service, communicating instructions, and processing a payment.

57. The method of claim 56, further comprising:
tracking the action item executed by a guest for the event separately; and
estimating a second amount for the action item executed by the guest.

58. The method of claim 57, further comprising:
generating a second consolidated invoice for the guest based on the second amount; and
rendering the second consolidated invoice for the guest in a second home currency of the guest.

59. The method of claim 50, wherein estimating the first amount for the action item executed by the host comprises:
tracking the action item executed by the guest;
determining a second amount spent by the guest based on tracking the action item executed by the guest;
comparing the second amount and a cap amount in the budget information; and
calculating a difference in amount between the second amount and the cap amount as the first amount.

60. The method of claim 50, further comprising:
generating a three-dimensional virtual model of an event venue as a virtual gallery using an event venue media file;
populating virtually, by the server using the artificial intelligence algorithm, the three-dimensional model of the event venue with the host and the guest; and
performing a simulation using the three-dimensional model to provide at least one of a virtual reality experience, an augmented reality experience, and a mixed reality experience of attending the event at the event venue in a real-time to the host and the guest.

61. The method of claim 60, further comprising:
enabling the guest and the host to interact and communicate virtually in the virtual gallery.

62. The method of claim 50, wherein receiving the input from the host device comprises:
receiving, by the server using a natural language processing algorithm, the input through a voice assistance device in at least one language in an audio format; and
converting, by the server using the natural language processing algorithm, the input in the at least one language to a computer understandable format.

63. The method of claim 62, further comprising:
analyzing, by the server using the artificial intelligence algorithm, the input received from the host device for a predefined time period;
discover, by the server using the artificial intelligence algorithm, at least one of a pattern and a behavior of the host based on the analysis; and
recommending a first predefined package to the host based on at least one of the pattern and the behavior of the host analyzed, wherein the first predefined package comprises at least one of the host information, the guest information, the activity information, the budget information, the event agenda, the vendor information, the return gift information, a guest, an additional guest list, and the reward information.

64. A system comprising:
a server that comprises a memory, and a processor communicatively coupled to the memory, the processor is configurable to
communicate an invite for an event to a guest device, wherein the invite comprises at least one of event information, host information, guest information, activity information, budget information, vendor information, and reward information;
receive at least one of a response and an event attending venue from the guest device in reply to the invite;
automatically determine, using an artificial intelligence algorithm, a first locale of a guest based on the event attending venue;
automatically generate, using the artificial intelligence algorithm, a purchase order for the guest based on the first locale, a second locale at which the event is planned, and an input received from a host device; and
automatically communicate the purchase order to a vendor at a predefined time prior to the event based on the first locale of the guest, wherein the purchase order comprises at least one of an item, a service, a delivery date, a delivery time, a mode of payment, a cap amount for the purchase order, a delivery instruction, and a delivery address.
